(19) United States
(12) Patent Application Publication
(10) Pub. No.: US 2019/0256144 A1
(43) Pub. Date: Aug. 22, 2019

(54) PARKING ASSIST APPARATUS

(71) Applicant: TOYOTA JIDOSHA KABUSHIKI KAISHA, Toyota-shi (JP)

(72) Inventors: Aya YAMADA, Atsugi-shi (JP); Hiroshi NAKAMURA, Gotemba-shi (JP); Nobutsugu MARUIWA, Mishima-shi (JP)

(73) Assignee: TOYOTA JIDOSHA KABUSHIKI KAISHA, Toyota-shi (JP)

(21) Appl. No.: 16/263,619

(22) Filed: Jan. 31, 2019

(30) Foreign Application Priority Data
Feb. 16, 2018 (JP) 2018-026254

(51) Int. Cl. B62D 15/02

(52) U.S. Cl. CPC B62D 15/0285; B60W 10/20

(57) ABSTRACT

A parking assist apparatus (13) has: a learning device (131) for learning, when a driver performs a parking operation, a specific position (WP_shift) that is a position of the vehicle (1) when a behavior of the vehicle satisfies a predetermined condition; a setting device (132) for setting a transit position (WP_transit) in a first predetermined area (CA) including the learned specific position; and a generating device (132) for generating, as a target route (TR_target), a first traveling route that reaches a target position (WP_end) via the set transit position, the setting device sets the transit position on the basis of a first evaluation score (SC1) of the first traveling route that is determined on the basis of at least a change rate of a curvature of the first traveling route and/or a distance between the first traveling route and a first obstacle that exists around the first traveling route.

### TECHNICAL FIELD

The present invention relates to a technical field of a parking assist apparatus that is configured to execute a parking assist for automatically parking a vehicle in a target position, for example.

### BACKGROUND ART

A Patent Literature 1 discloses one example of a parking assist apparatus. Specifically, the Patent Literature 1 discloses the parking assist apparatus that is configured to operate in two modes including a learning more and an operating mode. The parking assist apparatus operating in the learning mode is configured to learn a reference route along which a vehicle travels from a reference start position to a parking position when a driver parks the vehicle in the parking space (for example, a garage) by a driver's operation, wherein the reference start position is a position at which the vehicle starts to travel and the parking position is a position at which the vehicle is parked. The parking assist apparatus operating in the operating mode is configured to automatically park the vehicle in the parking space in which the vehicle is parked in the learning mode by using a leaning result in the learning mode. As a result, the vehicle is parked in a parking position that is same as a parking position in the parking space in which the vehicle is parked in the learning mode.

Note that there are a Patent Literature 2 and a Patent Literature 3 as another document relating to the present invention.

### CITATION LIST

### Patent Literature

[Patent Literature 1] Japanese Unexamined Patent Application Publication No. 2013-530867
[Patent Literature 2] Japanese Unexamined Patent Application Publication No. 2011-141854
[Patent Literature 3] Japanese Unexamined Patent Application Publication No. 2008-536734

### SUMMARY OF INVENTION

### Technical Problem

The parking assist apparatus disclosed in the Patent Literature 1 learns the reference route along which the vehicle travels from the reference start position at which the vehicle starts to travel to the parking position at which the vehicle is parked, in order to automatically park the vehicle in the parking space. However, there is a possibility that the driver's operation includes an unnecessary operation (for example, an operation that turns a steered wheel too much). Thus, there is a possibility that the driver's unnecessary operation affects the reference route learned by the parking assist apparatus in the learning mode. Therefore, there is a possibility that the parking assist apparatus disclosed in the Patent Literature 1 controls the vehicle such that the vehicle travels along an undesired traveling route, when the parking assist apparatus disclosed in the Patent Literature 1 automatically parks the vehicle in the parking space. Namely, there is a possibility that the parking assist apparatus disclosed in the Patent Literature 1 is not capable of allowing the vehicle to travel along a desired traveling route, when the parking assist apparatus disclosed in the Patent parks the vehicle in the parking space.

The above described technical problem is one example of the technical problem to be solved by the present invention. It is therefore an object of the present invention to provide, for example, a parking assist apparatus that is configured to park the vehicle in the parking space while allowing the vehicle to travel along the appropriate traveling route.

### Solution to Problem

One aspect of a parking assist apparatus of the present invention is provided with: a learning device that is configured to learn a specific position during a period when a driver performs a parking operation for parking a vehicle, the specific position being a position of the vehicle when a behavior of the vehicle satisfies a predetermined condition; a setting device that is configured to set a transit position in a first predetermined area that includes the specific position learned by the learning device; and a generating device that is configured to generate, as a target route along which the vehicle should travel when the vehicle is automatically parked at a target position at which the vehicle should be parked, a first traveling route that reaches the target position via the transit position set by the setting device, the setting device is configured to set the transit position on the basis of a first evaluation score of the first traveling route, wherein the first evaluation score is determined on the basis of at least a change rate of a curvature of the first traveling route and/or a distance between the first traveling route and a first obstacle that exists around the first traveling route.

### BRIEF DESCRIPTION OF DRAWINGS

FIG. 1 is a block diagram that illustrates a structure of a vehicle in a present embodiment.

FIG. 2 is a flowchart that illustrates a flow of a learning process in the present embodiment.

FIG. 3 is a planar view that illustrates distance between a traveling route and an obstacle.

FIG. 4 is a map that illustrates a relationship between a score component and a value of integral of the distance between the traveling route and the obstacle.

FIG. 5 Each of FIG. 5A to FIG. 5B is a planar view that illustrates a traveling route along which the vehicle actually travels when a driver parks the vehicle in a parking space by performing a parking operation.

FIG. 6 is a flowchart that illustrates a flow of a parking assist process in the present embodiment.

FIG. 7 is a planar view that illustrates a plurality of candidate waypoints.

FIG. 8 is a planar view that illustrates a traveling route along which the vehicle actually travels when the driver parks the vehicle in the parking space by performing the parking operation.

FIG. 9 is a planar view that illustrates a target route generated by a parking assist unit in the present embodiment.

FIG. 10 is a flowchart that illustrates a flow of the learning process in a first modified example.

FIG. 11 is a flowchart that illustrates a flow of a process of specifying a straight traveling start waypoint and a straight traveling end waypoint.

FIG. 12 Each of FIG. 12A to FIG. 12E is a graph that illustrates a curvature of the traveling route along which the vehicle actually travels when the driver parks the vehicle in the parking space by performing the parking operation.

FIG. 13 is a planar view that associates the straight traveling start waypoint and the straight traveling end waypoint with the traveling route along which the vehicle actually travels when the driver parks the vehicle in the parking space by performing the parking operation.

FIG. 14 is a flowchart that illustrates a flow of the parking assist process in the first modified example.

FIG. 15A is a planer view that illustrates the vehicle that travels away from the target route and FIG. 15B is a planar view that illustrates the newly generated target route.

### DESCRIPTION OF EMBODIMENTS

Hereinafter, with reference to drawings, one embodiment of the parking assist apparatus of the present invention will be described. In the following description, a vehicle 1 to which one embodiment of the parking assist apparatus of the present invention is adapted will be described.

### (1) Structure of Vehicle 1

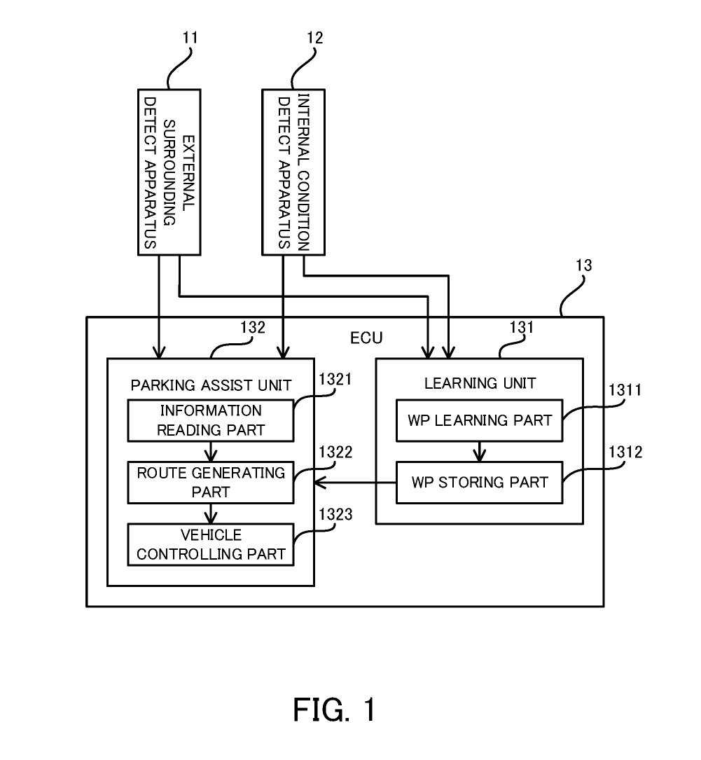

Firstly, with reference to FIG. 1, the structure of the vehicle 1 in the present embodiment will be explained. As illustrated in FIG. 1, the vehicle 1 has: an external surrounding detect apparatus 11; an internal condition detect apparatus 12; and an ECU (Electronic Control Unit) 13 that is one example of each of a “parking assist apparatus” and a “controller” in a below described additional statement.

The external surrounding detect apparatus 11 is a detect apparatus that is configured to detect an external surrounding (in other words, an external circumstance, condition or situation) of the vehicle 1. The external surrounding may include a condition or a situation around the vehicle (what we call a traveling environment or a driving environment), for example. The external surrounding detect apparatus 11 includes at least one of a camera, a radar and a LIDAR (Light Detection and Ranging), for example.

The internal condition detect apparatus 12 is a detect apparatus that is configured to detect an internal condition (in other words, an internal state) of the vehicle 1. The internal condition may include a traveling condition (in other words, a driving condition) of the vehicle 1, for example. The internal condition may include an operating condition (in other words, an operating state) of each of various devices of the vehicle 1, for example. The internal condition detect apparatus 12 includes at least one of a speed sensor that is configured to detect a speed of the vehicle 1, a shift position sensor that is configured to detect a shift range (in other words, a gear range or a shift position) of the vehicle 1, a steering angle sensor that is configured to detect a steering angle (for example, a rotational angle) of a steering wheel of the vehicle 1, a steered angle sensor that is configured to detect a steered angle (in other words, a rudder angle) of a steered wheel (in other word, a steered tire) of the vehicle 1 and a position sensor (for example, a GPS (Global Positioning System) sensor) that is configured to detect a position of the vehicle 1.

The ECU 13 is configured to control entire operation of the vehicle 1. Especially in the present embodiment, the ECU 13 is configured to execute a learning process for learning, as a waypoint WP, the position of the vehicle 1 at a timing when a behavior of the vehicle 1 satisfies a specific condition, when a driver parks the vehicle 1 in a desired parking space SP. Moreover, the ECU 13 is configured to execute a parking assist process for automatically parking the vehicle 1 in the desired parking space SP on the basis of the waypoint WP learned by the learning process.

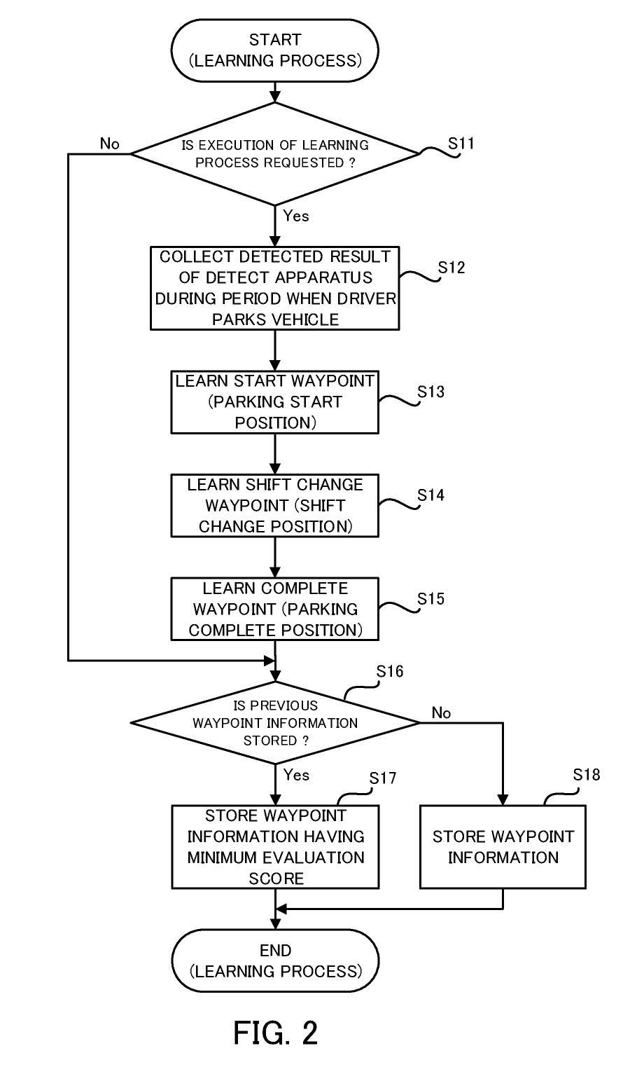

In order to execute the learning process, the ECU 13 includes, as a processing block that is logically realized in the ECU 13 or a processing circuit that is physically realized in the ECU 13, a learning unit 131 that is one example of a “learning device” in the below described additional statement. The learning unit 131 includes, as processing blocks that are logically realized in the learning unit 131 or processing circuits that are physically realized in the learning unit 131, a waypoint learning part 1311 (hereinafter, the waypoint learning part 1311 is referred to as a “WP learning part 1311”) and a waypoint storing part 1312 (hereinafter, the waypoint storing part 1312 is referred to as a “WP storing part 1312”). Moreover, in order to execute the parking assist process, the ECU 13 includes, as a processing block that is logically realized in the ECU 13 or a processing circuit that is physically realized in the ECU 13, a parking assist unit 132. The parking assist unit 132 includes, as processing blocks that are logically realized in the parking assist unit 132 or processing circuits that are physically realized in the parking assist unit 132, an information reading part 1321, a route generating part 1322 that is one example of each of a “setting device” and a “generating device” in the below described additional statement and a vehicle controlling part 1323. Note that the operation of each of the learning unit 131 and the parking assist unit 132 will be described later in detail with reference to FIG. 2 and so on.

### (2) Operation of ECU 13

Next, the learning process and the parking assist process that are executed by the ECU 13 will be described in order.

### (2-1) Flow of Learning Process

Firstly, with reference to FIG. 2, a flow of the learning process in the present embodiment will be described. FIG. 2 is a flowchart that illustrates the flow of the learning process in the present embodiment.

As illustrated in FIG. 2, the learning unit 131 determines whether or not the driver requests an execution of the learning process (a step S11). Specifically, the learning unit 131 determines whether or not the driver operates an operating apparatus (especially, an operating apparatus that is configured to be operated by the driver to request the execution of the learning process) of the vehicle 1. If the driver operates the operating apparatus, the learning unit 131 determines that the driver requests the execution of the learning process. Note that the learning process is executed when the driver performs a parking operation for parking the vehicle 1 in the desired parking space SP. Thus, the driver typically requests the execution of the learning process before starting to perform the parking operation.

As a result of the determination at the step S11, if it is determined that the driver does not request the execution of the learning process (the step S11: No), the learning unit 131 terminates the learning process illustrated in FIG. 2. When the learning unit 131 terminates the learning process illustrated in FIG. 2, the learning unit 131 starts the learning process illustrated in FIG. 2 again after a first predetermined period elapses.

On the other hand, as a result of the determination at the step S11, if it is determined that the driver requests the execution of the learning process (the step S11: Yes), the WP learning part 1311 collects a detection information that is a detected result of the external circumstance detect apparatus 11 and the internal condition detect apparatus 12 during a period when the driver parks the vehicle 1 by performing the parking operation (a step S12). Note that the process at step S12 may be executed in parallel with the processes from a below described steps S13 to S15, because the learning process is executed during a period when the driver performs the parking operation.

Then, the WP learning part 1311 learns, as a start waypoint WP_start, the position of the vehicle 1 at a parking start timing at which the driver starts the parking operation on the basis of the detection information collected at the step S12 (a step S13). Namely, the WP learning part 1311 learns a parking start position as the start waypoint WP_start. The parking start timing may be a timing at which the driver requests the execution of the learning process. Alternatively, the parking start timing may be a timing at which the vehicle 1 starts to travel (in other words, move). Namely, the parking start timing may be a timing at which the speed of the vehicle 1 changes from zero to a value larger than zero. Alternatively, the parking start timing may be a timing at which the shift range of the vehicle 1 is changed from one range (for example, a P (Parking) range or a N (Neutral) range) that is used when the vehicle 1 stops to another range (for example, a D (Drive) range or a R (Reverse) range) that is used when the vehicle 1 travels. Note that the present embodiment is described by using an example in which the parking start timing is the timing at which the shift range of the vehicle 1 is changed from the P range or the N range to the D range, for the purpose of simple description. Namely, the present embodiment is described by using an example in which the driver parks the vehicle 1 in the parking space SP by making the vehicle 1 travel frontward from the parking start position.

Moreover, the WP learning part 1311 learns, as a shift change waypoint WP_shift, the position of the vehicle 1 at a shift change timing at which the driver changes the shift range in order to change a traveling direction of the vehicle 1 after the driver starts the parking operation on the basis of the detection information collected at the step S12 (a step S14). Namely, the WP learning part 1311 learns a shift change position as the shift change waypoint WP_shift. The shift change timing is a timing at which the shift range is changed from one range (for example, the D range) that is used to make the vehicle 1 travel frontward to another range (for example, the R range) that is used to make the vehicle 1 travel backward or from one range (for example, the R range) that is used to make the vehicle 1 travel backward to another range (for example, the D range) that is used to make the vehicle 1 travel frontward. Note that the present embodiment is described by using an example in which the shift change timing is the timing at which the shift range of the vehicle 1 is changed from the D range to the R range, for the purpose of simple description. Namely, the present embodiment is described by using an example in which the driver moves the vehicle 1 to a desired position by making the vehicle 1 travel frontward from the parking start position and then parks the vehicle 1 in the parking space SP by making the vehicle 1 travel backward.

Moreover, the WP learning part 1311 learns, as a complete waypoint WP_end, the position of the vehicle 1 at a parking complete timing at which the driver completes (in other words, ends or finishes) the parking operation on the basis of the detection information collected at the step S12 (a step S15). Namely, the WP learning part 1311 learns a parking complete position as the complete waypoint WP_end. The parking complete timing may be a timing at which the driver requests an end (in other words, a termination) of the learning process. Alternatively, the parking complete timing may be a timing at which a predetermined time elapses after the vehicle 1 stops. Namely, the parking complete timing may be a timing at which the predetermined time elapses after the speed of the vehicle 1 changes from the value larger than zero to zero. Alternatively, the parking complete timing may be a timing at which the shift range of the vehicle 1 is changed from one range that is used when the vehicle 1 travels to another range that is used when the vehicle 1 stops. Note that the present embodiment is described by using an example in which the parking complete timing is the timing at which the shift range of the vehicle 1 is changed from the R range to the P range, for the purpose of simple description.

Then, the WP learning part 1311 makes the WP storing part 1312 store a waypoint information (hereinafter, the waypoint information is referred to as a “WP information”) including an information set of the learned start waypoint WP_start, the learned shift change waypoint WP_shift and the learned complete waypoint WP_end. In order to make the WP storing part 1312 store the WP information, the WP learning part 1311 firstly determines whether or not the WP information obtained in the past is already stored in the WP storing part 1312 (a step S16). Specifically, the WP learning part 1311 determines whether or not the WP storing part 1312 already stores the WP information including the start waypoint WP_start and the complete waypoint WP_end that are same as or near to the start waypoint WP_start and the complete waypoint WP_end that are newly obtained at this time learning process, respectively. If the WP storing part 1312 already stores the WP information including the start waypoint WP_start and the complete waypoint WP_end that are same as or near to the start waypoint WP_start and the complete waypoint WP_end that are newly obtained at this time learning process, respectively, the WP learning part 1311 determines that the WP information obtained in the past is already stored in the WP storing part 1312.

As a result of the determination at the step S16, if it is determined that the WP information obtained in the past is not stored in the WP storing part 1312 (the step S16: No), the WP learning part 1311 makes the WP storing part 1312 store new WP information including the start waypoint WP_start, the shift change waypoint WP_shift and the complete waypoint WP_end that are newly obtained by this time learning process (a step S18).

On the other hand, as a result of the determination at the step S16, if it is determined that the WP information obtained in the past is already stored in the WP storing part 1312 (the step S16: Yes), the WP learning part 1311 makes the WP storing part 1312 store either one of the already stored WP information (namely, the WP information obtained in the past, and it is referred to as a “previous WP information”) and the WP information newly obtained by this time learning process (it is referred to as a “new WP information”) (a step S17). In order to determine which WP information (namely, the previous WP information and the new WP information) is stored in the WP storing part 1312, the WP learning part 1311 calculates an evaluation score SC1 of each of the previous WP information and the new WP information.

The evaluation score SC1 is a quantitative index value that represents an optimum degree (in other word, a degree of a goodness or an appropriateness) of a traveling route TR_actual along which the vehicle 1 actually travels by the parking operation. When the traveling route TR_actual is appropriate, there is a relatively high possibility that the parking operation is appropriate. Therefore, it can be said that the evaluation score SC1 is a quantitative index value that represents an optimum degree of the parking operation performed by the driver. Note that the present embodiment uses an example in which the evaluation score SC1 is defined so that the evaluation score SC1 becomes smaller as the traveling route TR_actual becomes more appropriate.

The evaluation score SC1 is an index value that is determined on the basis of a change rate of a curvature of the traveling route TR_actual. Specifically, the evaluation score SC1 is an index value that is determined on the basis of the premise that the traveling route TR_actual becomes more appropriate as the change rate of the curvature of the traveling route TR_actual becomes smaller, for example. This is because it is estimated that the driver performs the steering operation smoother (and as a result, a load of a steering actuator is smaller when this smother steering operation is executed by the parking assist process) as the change rate of the curvature of the traveling route TR_actual becomes smaller. In the present embodiment, the evaluation score SC1 includes a score component SC1a that becomes smaller as the change rate of the curvature of the traveling route TR_actual becomes smaller. In order to calculate the score component SC1a, the WP learning part 1311 calculates the change rate of the curvature per unit time or per unit traveling distance on the basis of the detection information collected at the step S12. For example, the WP learning part 1311 may determine the traveling route TR_actual on the basis of the detection information collected at the step S12, and then calculate the change rate of the curvature on the basis of the determined traveling route TR_actual. Alternatively, the WP learning part 1311 may calculate the change rate of the curvature on the basis of a parameter of the vehicle 1 that is correlated with the change rate of the curvature. At least one of the steering angle of the steering wheel, the steered angle of the steered wheel, a deflection angle of the vehicle 1 and a yaw rate of the vehicle 1 is one example of the parameter of the vehicle 1 that is correlated with the change rate of the curvature. Then, the WP learning part 1311 integrates the calculated change rate of the curvature (especially, its absolute value or squared value) along whole traveling route TR_actual. The value obtained by integrating the change rate of the curvature is the score component SC1a. Note that one of the reason why the absolute value or the squared value of the change rage of the curvature is used is to eliminate the adverse effect due to a difference in a sign of the change rate of the curvature. However, WP learning part 1311 may calculate the score component SC1a by using another method, as long as the calculated score component SC1a becomes smaller as the change rate of the curvature becomes smaller.

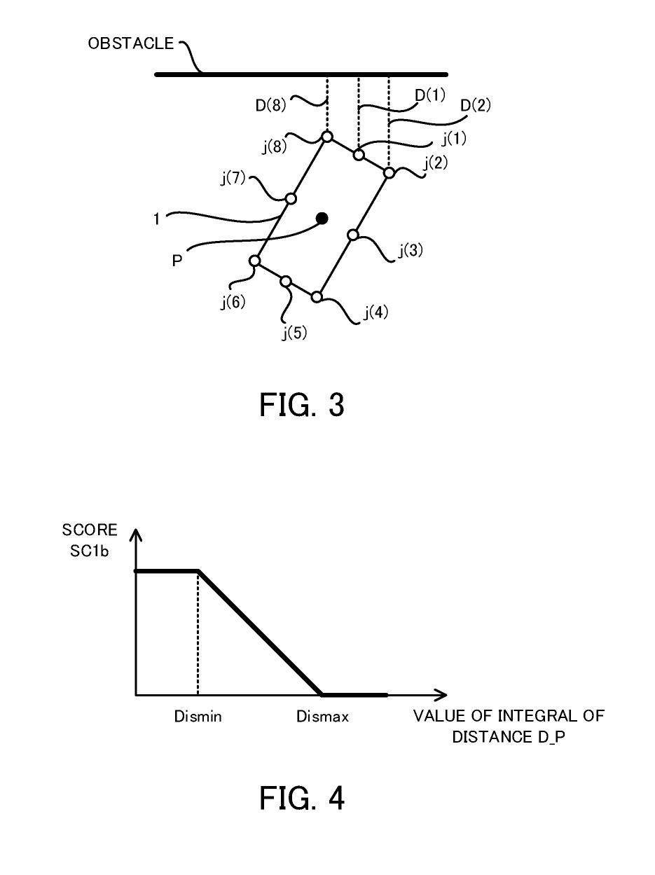

The evaluation score SC1 is an index value that is determined on the basis of a distance between the traveling route TR_actual and an obstacle (namely, an object that prevents the vehicle 1 from traveling) that exists around the traveling route TR_actual, for example. Specifically, the evaluation score SC1 is an index value that is determined on the basis of the premise that the traveling route TR_actual becomes more appropriate as the distance between the traveling route TR_actual and the obstacle becomes larger, for example. This is because the possibility that the vehicle 1 collides with the obstacle is estimated to be lower as the distance between the traveling route TR_actual and the obstacle becomes larger. In the present embodiment, the evaluation score SC1 includes a score component SC1b that becomes smaller as the distance between the traveling route TR_actual and the obstacle becomes larger. In order to calculate the score component SC1b, the WP learning part 1311 calculates a distance D_P between the obstacle and a specific spot P on the traveling route TR_actual on the basis of the detection information collected at the step S12. The distance D_P between the obstacle and the specific spot P means a total sum of distances D between the obstacle and a plurality of edge points j of the vehicle 1 located at the specific spot P. For example, as illustrated in FIG. 3, if eight edge points j(1) to j(8) are set as the edge points j of the vehicle 1, the WP learning part 1311 calculates a total sum of a distance D(1) between the obstacle and the edge point j(1), a distance D(2) between the obstacle and the edge point j(2), . . . , and a distance D(8) between the obstacle and the edge point j(8). If there are a plurality of obstacles, the WP learning part 1311 calculates, as the distance D_P, a total sum of distances between the plurality of obstacles and the specific spot P. Then, the WP learning part 1311 integrates the calculated distance D_P along whole the traveling route TR_actual. Namely, the WP learning part 1311 calculates the distance D_P while moving the specific spot P along the traveling route TR_actual and integrates the calculated distance D_P. Then, the WP learning part 1311 calculates the score component SC1b on the basis of the value obtained by integrating the distance D_P. For example, the WP learning part 1311 calculates the score component SC1b on the basis of a map that represents a relationship between the value obtained by integrating the distance D_P and the score component SC1b, as illustrated in FIG. 4. Note that FIG. 4 illustrate an example of the map in which (i) the score component SC1b becomes smaller as the value obtained by integrating the distance D_P becomes larger, when the value obtained by integrating the distance D_P is equal to or larger than a threshold value Dismin and equal to or smaller than a threshold value Dismax (note that the threshold value Dismax is larger than the threshold value Dismin), (ii) the score component SC1b is constant (specifically, is fixed to the score component SC1b used when the value obtained by integrating the distance D_P is equal to the threshold value Dismin) regardless of the value obtained by integrating the distance D_P, when the value obtained by integrating the distance D_P is smaller than threshold value Dismin, and (iii) the score component SC1b is constant (specifically, is fixed to the score component SC1b used when the value obtained by integrating the distance D_P is equal to the threshold value Dismax) regardless of the value obtained by integrating the distance D_P, when the value obtained by integrating the distance D_P is larger than threshold value Dismax. However, WP learning part 1311 may calculate the score component SC1b by using another method, as long as the calculated score component SC1b becomes smaller as the distance between the traveling route TR_actual and the obstacle becomes larger.

The evaluation score SC1 is an index value that is determined on the basis of the number of the operation of returning the steering wheel (namely, how many times the driver changes the rotational direction of the steering wheel) during the period when the vehicle 1 travels along the traveling route TR_route, for example. Specifically, the evaluation score SC1 is an index value that is determined on the basis of the premise that the traveling route TR_actual becomes more appropriate as the number of the operation of returning the steering wheel becomes lower, for example. This is because it is estimated that the time required for parking the vehicle 1 becomes shorter (namely, the vehicle 1 is parked smoother (in other words, more efficiently)) as the number of the operation of returning the steering wheel becomes lower. Moreover, it is estimated that the driver performs the steering operation smoother (and as a result, the load of the steering actuator is smaller when this smother steering operation is executed by the parking assist process) as the number of the operation of returning the steering wheel becomes lower. In the present embodiment, the evaluation score SC1 includes a score component SC1c that becomes smaller as the number of the operation of returning the steering wheel becomes smaller. In order to calculate the score component SC1c, the WP learning part 1311 calculates the number of the operation of returning the steering wheel during the period when the vehicle 1 travels along the traveling route TR_actual on the basis of the detection information collected at the step S12. For example, the WP learning part 1311 may calculate the number of the operation of returning the steering wheel on the basis of at least one of the steering angle of the steering wheel and the steered angle of the steered wheel. The calculated number of returning the steering wheel may be directly used as the score component SC1c.

The evaluation score SC1 is an index value that is determined on the basis of a length of the traveling route TR_actual (namely, a traveling distance of the vehicle 1 until the driver completes the parking operation), for example. Specifically, the evaluation score SC1 is an index value that is determined on the basis of the premise that the traveling route TR_actual becomes more appropriate as the traveling route TR_actual becomes shorter, for example. This is because it is estimated that the time required for parking the vehicle 1 becomes shorter as the traveling route TR_actual becomes shorter. In the present embodiment, the evaluation score SC1 includes a score component SC1d that becomes smaller as the traveling route TR_actual becomes shorter. In order to calculate the score component SC1d, the WP learning part 1311 calculates the length of the traveling route TR_actual (namely, the traveling distance of the vehicle 1) on the basis of the detection information collected at the step S12. For example, the WP learning part 1311 may calculate the length of the traveling route TR_actual on the basis of the speed of the vehicle 1. The calculated length of the traveling route TR_actual may be directly used as the score component SC1d.

The WP learning part 1311 calculates the evaluation score SC1 by multiplying the score components SC1a to SC1d with weighting factors w1a to w1d, respectively, and then adding them. Namely, the WP learning part 1311 calculates the evaluation score SC1 by using a mathematical formula of SC1=SC1a×w1a+SC1b×w1b+SC1c×w1c+SC1d×w1d. The weighting factors w1a to w1d are set on the basis of a degree of an emphasis of each of the change rage of the curvature of the traveling route TR_actual, the distance between the traveling route TR_actual and the obstacle, the number of returning the steering wheel and the length of the traveling route TR_actual when the optimum degree of the traveling route TR_actual is evaluated. Typically, the weighting factor corresponding to the parameter that should be emphasized is set to a relatively large value. For example, when the change rage of the curvature of the traveling route TR_actual is emphasized, the weighting factor w1a is set to a relatively larger value. The weighting factors w1a to w1d may be set in advance when a program is embedded to the ECU 13. The weighting factors w1a to w1d may be set by the ECU 13 or may be set by the driver. However, the weighting factors w1a to w1d may not be used.

The WP learning part 1311 calculates the evaluation score SC1 of the traveling route TR_actual corresponding to the previous WP information and the evaluation score SC1 of the traveling route TR_actual corresponding to the new WP information. Note that the evaluation score SC1 of the traveling route TR_actual corresponding to the previous WP information may be included in the previous WP information. In this case, the WP learning part 1311 may obtain the evaluation score SC1 of the traveling route TR_actual corresponding to the previous WP information from the previous WP information instead of newly calculating the evaluation score SC1 of the traveling route TR_actual corresponding to the previous WP information.

Then, the WP learning part 1311 determines which is smaller (namely, the smallest), the evaluation score SC1 of the traveling route TR_actual corresponding to the previous WP information or the evaluation score SC1 of the traveling route TR_actual corresponding to the new WP information. If it is determined that the evaluation score SC1 of the traveling route TR_actual corresponding to the new WP information is smaller than the evaluation score SC1 of the traveling route TR_actual corresponding to the previous WP information, the WP learning part 1311 makes the WP storing part 1312 store the new WP information. On the other hand, if it is determined that the evaluation score SC1 of the traveling route TR_actual corresponding to the new WP information is larger than the evaluation score SC1 of the traveling route TR_actual corresponding to the previous WP information, the WP learning part 1311 makes the WP storing part 1312 keep storing the previous WP information. Namely, the WP learning part 1311 makes the WP storing part 1312 store the WP information having the smaller evaluation score SC1 (namely, the smallest evaluation score SC1). In this case, the WP learning part 1311 may make the WP storing part 1312 store the WP information that additionally includes the calculated evaluation score SC1.

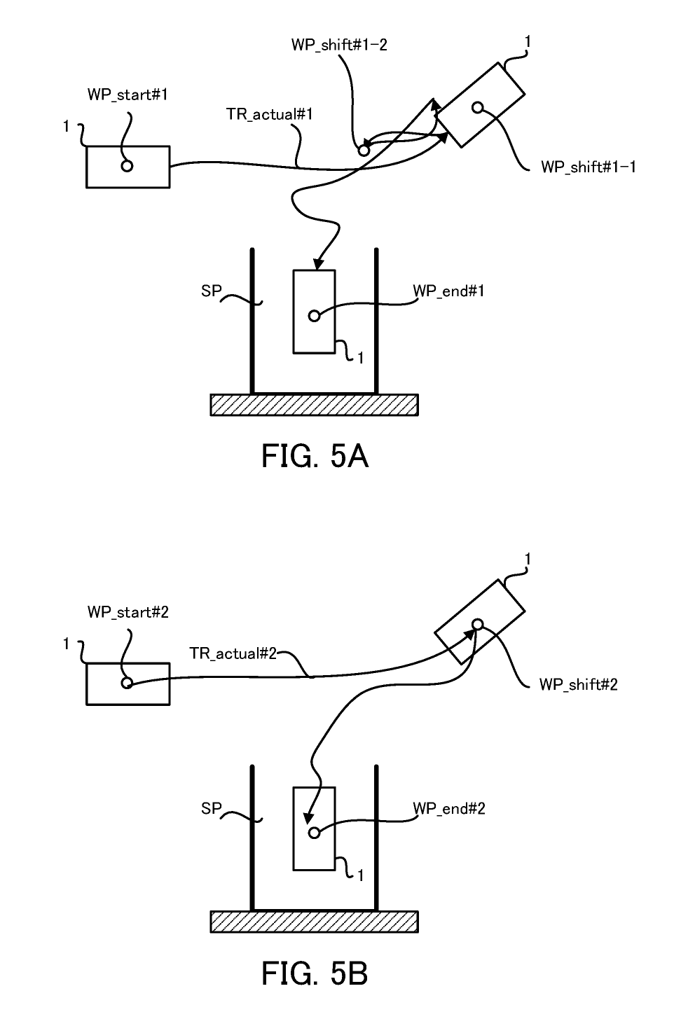

Each of FIG. 5A and FIG. 5B illustrates one example of the traveling route TR_actual. FIG. 5A illustrates a traveling route TR_actual #1 in which the change rate of the curvature is relatively large, the number of returning the steering wheel is relatively large and the length is relatively long. On the other hand, FIG. 5B illustrates a traveling route TR_actual #2 in which the change rate of the curvature is relatively small, the number of returning the steering wheel is relatively low and the length is relatively short than those of the traveling route TR_actual #1. In this case, the evaluation score SC1 of the traveling route TR_actual #2 is smaller than the evaluation score SC1 of the traveling route TR_actual #1. As a result, if either one of the new WP information and the previous WP information is the WP information corresponding to the traveling route TR_actual #1 and the other one of the new WP information and the previous WP information is the WP information corresponding to the traveling route TR_actual #2, the WP learning part 1311 makes the WP storing part 1312 store the WP information corresponding to the traveling route TR_actual #2. Namely, the WP learning part 1311 makes the WP storing part 1312 store the WP information including the start waypoint WP_start #2, the shift change waypoint WP_shift #2 and the complete waypoint WP_end #2 corresponding to the traveling route TR_actual #2.

### (2-2) Flow of Parking Assist Process

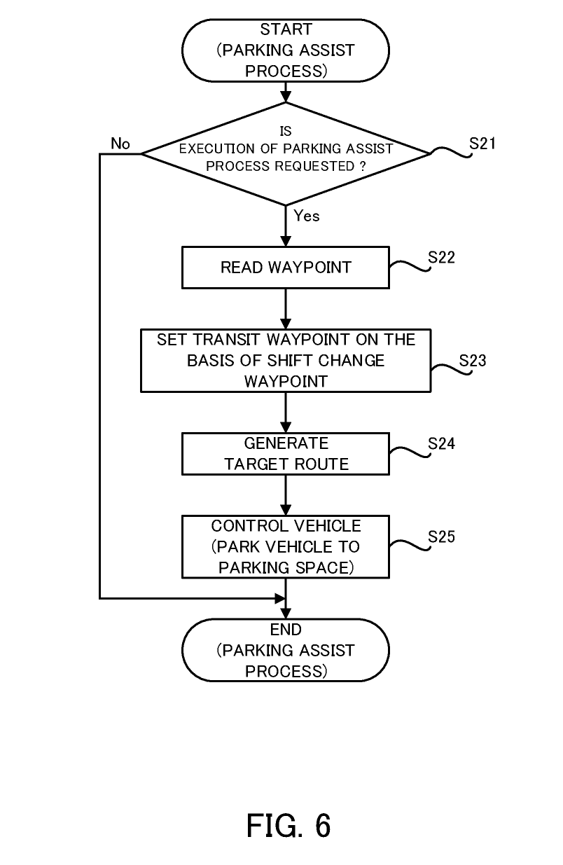

Next, with reference to FIG. 6, a flow of the parking assist process in the present embodiment will be described. FIG. 6 is a flowchart that illustrates the flow of the parking assist process in the present embodiment.

As illustrated in FIG. 6, the parking assist unit 132 determines whether or not the driver requests an execution of the parking assist process (a step S21). Specifically, the parking assist unit 132 determines whether or not the driver operates an operating apparatus (especially, an operating apparatus that is configured to be operated by the driver to request the execution of the parking assist process) of the vehicle 1. If the driver operates the operating apparatus, the parking assist unit 132 determines that the driver requests the execution of the parking assist process.

As a result of the determination at the step S21, if it is determined that the driver does not request the execution of the parking assist process (the step S21: No), the parking assist unit 132 terminates the parking assist process illustrated in FIG. 6. When the parking assist unit 132 terminates the parking assist process illustrated in FIG. 6, the parking assist unit 132 starts the parking assist process illustrated in FIG. 6 again after a second predetermined period elapses.

On the other hand, as a result of the determination at the step S21, if it is determined that the driver requests the execution of the parking assist process (the step S21: Yes), the information reading part 1321 reads (in other words, gets, receives or obtains) the WP information stored by the WP storing part 1312 (a step S22). Especially, the information reading part 1321 reads the WP information that includes the complete waypoint WP_end that is same as or near to the position of the parking space SP in which the vehicle 1 should be parked by this time parking assist operation.

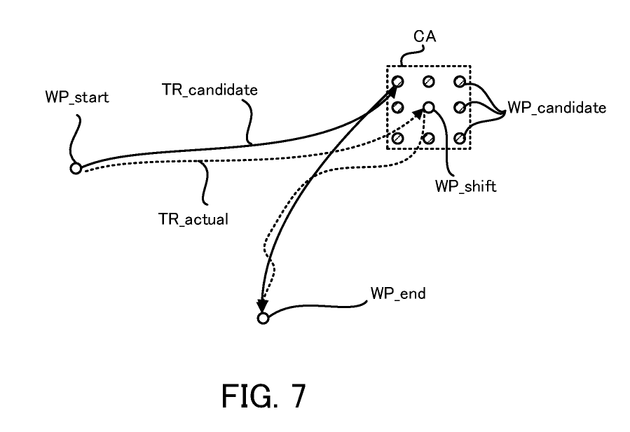

Then, the route generating part 1322 sets, on the basis of the shift change waypoint WP_shift included in the WP information read at the step S22, a transit waypoint WP_transit through which the vehicle 1 traveling by the parking assist process passes (a step S23). Specifically, as illustrated in FIG. 7, the route generating part 1322 sets a plurality of candidate waypoints WP_candidate each of which is a candidate of the transit waypoint WP_transit in a predetermined area CA. The predetermined area CA is an area including the shift change waypoint WP_shift included in the WP information read at the step S22. In this case, the route generating part 1322 may set the plurality of candidate waypoints WP_candidate that are arranged evenly in the predetermined area CA. Alternatively, the route generating part 1322 may set the plurality of candidate waypoints WP_candidate that are located or arranged in local or random area(s) in the predetermined area CA that allows the below described target route TR_target to be appropriate (for example, that allows a below described evaluation score SC2 to be relatively small). The route generating part 1322 selects, as the transit waypoint WP_transit, one of the plurality of candidate waypoints WP_candidate.

The number of the candidate waypoints WP_candidate that can be set in the predetermined area CA becomes larger, as the predetermined area CA becomes larger. Therefore, there is a relatively high possibility that the optimum transit waypoint WP_transit can be set. On the other hand, a load of the route generating part 1322 for selecting, as the transit waypoint WP_transit, one of the plurality of candidate waypoint WP_candidate becomes higher, as the predetermined area CA becomes larger. Thus, a size of the predetermined area CA may be set to an appropriate size on the basis of a trade-off between an advantage that the optimum transit waypoint WP_transit can be set and a disadvantage that the load of the route generating part 1322 becomes high.

In order to select one of the plurality of candidate waypoints WP_candidate as the transit waypoint WP_transit, the route generating part 1322 calculates the evaluation score SC2 for each of the plurality of candidate waypoints WP_candidate. The evaluation score SC2 is a quantitative index value that represents an optimum degree (in other word, a degree of a goodness or an appropriateness) of a traveling route TR_candidate that reaches the complete waypoint WP_end included in the WP information read at the step S22 from the current position of the vehicle 1 or the start waypoint WP_start included in the WP information read at the step S22 via the candidate waypoint WP_candidate. As described later, the route generating part 1322 generates, as the target route TR_target, a traveling route that reaches the complete waypoint WP_end from the current position of the vehicle 1 or the start waypoint WP_start via the transit waypoint WP_transit. Therefore, the traveling route TR_candidate corresponds to a candidate of the target route TR_target.

The evaluation score SC2 is different from the above described evaluation score SC1 in that the evaluation score SC2 is the index value that represents the optimum degree of the traveling route TR_candidate and the evaluation score SC1 is the index value that represents the optimum degree of the traveling route TR_actual. Another feature of the evaluation score SC2 is same as another feature of the evaluation score SC1. Namely, the above described description relating to the evaluation score SC1 is used as the description relating to the evaluation score SC2, if the term “traveling route TR_actual” is replaced by the term “traveling route TR_candidate”. Thus, the route generating part 1322 calculates the evaluation score SC2 on the basis of a score component SC2a that becomes smaller as the change rate of the curvature of the traveling route TR_candidte becomes smaller, a score component SC2b that becomes smaller as the distance between the traveling route TR_candidate and an obstacle that exist around the traveling route TR_candidate becomes larger, a score component SC2c that becomes smaller as the number of the operation of returning the steering wheel when the vehicle 1 travels along the traveling route TR_candidate becomes smaller, a score component SC2d that becomes smaller as the traveling route TR_candidate becomes shorter and weighting factors w2a to w2d, for example. Namely, the route generating part 1322 calculates the evaluation score SC2 by using a mathematical formula of SC2=SC2a×w2a+SC2b×w2b+SC2c×w2c+SC2d×w2d. Note that the weighting factors w2a to w2d used in the parking assist process are same as the weighting factors w1a to w1d used in the learning process, respectively. However, the weighting factors w2a to w2d used in the parking assist process may be different from the weighting factors w1a to w1d used in the learning process, respectively.

As illustrated in FIG. 7, the traveling route TR_candidate is set near the traveling route TR_actual. Thus, there is a relatively high possibility that the obstacle existing around the traveling route TR_actual is same as the obstacle existing around the traveling route TR_candidate. As a result, there is a relatively high possibility that the obstacle existing around the traveling route TR_actual is same as the obstacle existing around the target route TR_target. Therefore, selecting the WP information that is used to generate the target route TR_target on the basis of the evaluation score SC1 based on the distance between the traveling route TR_actual and the obstacle existing around the traveling route TR_actual contributes to generating the target route TR_target so that the distance between the target route TR_target and the obstacle existing around the target route TR_target becomes relatively large. Note that the obstacle existing around the traveling route TR_actual is expected to be same as the obstacle existing around the traveling route TR_candidate, if the obstacle is a fixed object such as a building. On the other hand, the obstacle existing around the traveling route TR_actual may not be same as the obstacle existing around the traveling route TR_candidate, if the obstacle is a movable object such as another vehicle.

Then, the route generating part 1322 selects, as the transit waypoint WP_transit, one candidate waypoint WP_candidate achieving the smallest evaluation score SC2 from the plurality of candidate waypoints WP_candidate. Namely, the route generating part 1322 sets the transit waypoint WP_transit so that the evaluation score SC2 of the target route TR_target that reaches the complete waypoint WP_end from the start waypoint WP_start or the current position of the vehicle 1 via the transit waypoint WP_transit is minimized. In other words, the route generating part 1322 sets the transit waypoint WP_transit so that the traveling route TR_candidate having the smallest evaluation score SC2 is set to the target route TR_target.

Then, the route generating part 1322 generates, as the target route TR_target along which the vehicle 1 should travel, a traveling route that reaches the complete waypoint WP_end included in the WP information read at the step S22 via the transit waypoint WP_transit set at the step S23 (a step S24). In this case, if the vehicle 1 is at or near the start waypoint WP_start at a timing when it is determined that the driver requests the execution of the parking assist process, the route generating part 1322 generates, as the target route TR_target, a traveling route that reaches the complete waypoint WP_end from the start waypoint WP_start included in the WP information read at the step S22 via the transit waypoint WP_transit. On the other hand, if the vehicle 1 is not near the start waypoint WP_start (for example, the vehicle 1 is away from the start waypoint WP_start by a predetermined distance or more) at the timing when it is determined that the driver requests the execution of the parking assist process, the route generating part 1322 generates, as the target route TR_target, a traveling route that reaches the complete waypoint WP_end from the current position of the vehicle 1 via the transit waypoint WP_transit. Note that the existing method of generating the traveling route along which the vehicle 1 travels via a specified position may be used and thus the detailed description of the method of generating the traveling route will be omitted for the purpose of simple description.

Then, the vehicle controlling part 1323 makes the vehicle 1 automatically travel along the target route TR_target generated at the step S24 by controlling at least one of a power source (for example, an engine) of the vehicle 1, a brake apparatus of the vehicle 1, a steering apparatus of the vehicle 1 and a gear mechanism (in other words, transmission mechanism) of the vehicle 1 (a step S25). Namely, the vehicle controlling part 1323 makes the vehicle 1 travel automatically so that the vehicle 1 reaches the complete waypoint WP_end from the start waypoint WP_start or the current position of the vehicle 1 via the transit waypoint WP_transit. Note that the present embodiment is described by using an example in which the vehicle 1 is located at the start waypoint WP_start at the timing when it is determined that the driver requests the execution of the parking assist process, for the purpose of simple description. As a result, the vehicle 1 is automatically parked in the parking space SP without requiring the user's operation of an acceleration pedal, a brake pedal, a steering wheel and a shift lever (in other words, a selector).

### (3) Technical Effect

As described above, in the present embodiment, it is enough for the learning unit 131 to learn the start waypoint WP_start, the shift change waypoint WP_shift and the complete waypoint WP_end in order to automatically park the vehicle 1 in the parking space SP. Namely, the learning unit 131 need not learn whole traveling route TR_actual along which the vehicle 1 actually travels during the period when the driver drives the vehicle 1. Thus, the parking assist unit 132 is capable of generating the target route TR_target that is less likely affected by a driver's unnecessary operation, compared to a parking assist unit in a comparison example that is configured to generate the target route TR_target on the basis of the learned result of the traveling route TR_actual itself along which the vehicle 1 actually travels.

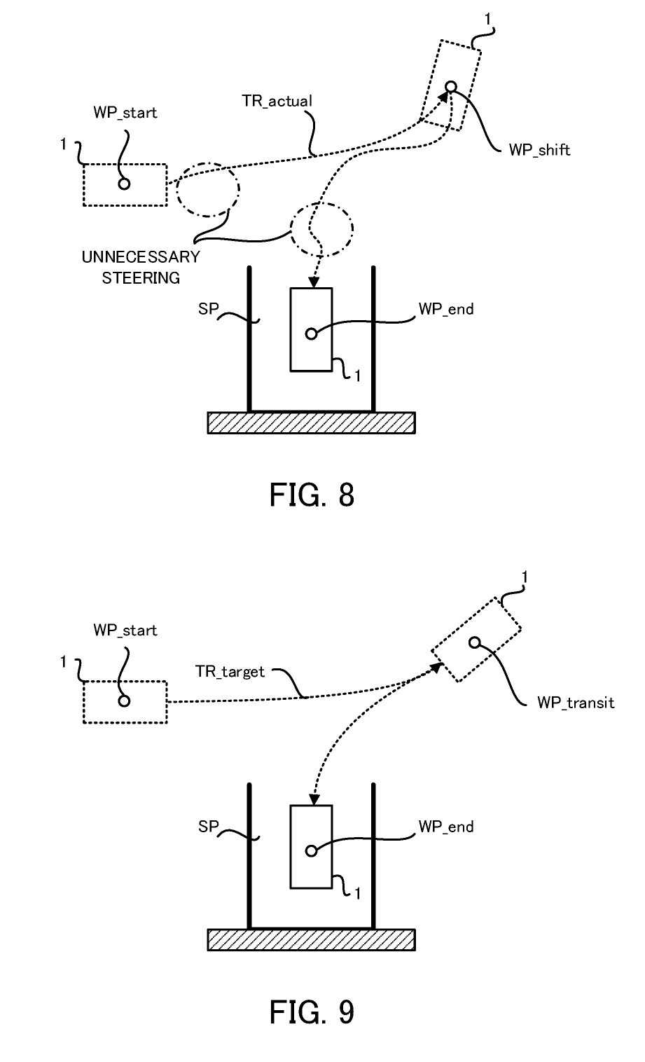

Specifically, FIG. 8 is a planar view that illustrates the traveling route TR_actual along which the vehicle 1 actually travels when the driver parks the vehicle 1 in the parking space SP by performing the parking operation. As illustrated in FIG. 8, there is a relatively high possibility that the traveling route TR_actual is affected by the driver's unnecessary operation. The driver's unnecessary operation includes an unnecessary steering operation that is at least one portion of a steering operation for steering the steered wheel and that does not contribute to the parking of the vehicle 1, for example. The steering operation that does not contribute to the parking of the vehicle 1 corresponds to a steering operation without which the vehicle 1 can be parked in the parking space SP appropriately. The steering operation that does not contribute to the parking of the vehicle 1 includes at least one of a first steering operation for steering the steered wheel too much and a second steering operation for returning the steered wheel that is already steered too much, for example. Moreover, if the driver performs the steering operation that does not contribute to the parking of the vehicle 1, a position (in other words, a timing) at which the driver changes the shift range is not necessarily optimum. If the traveling route TR_actual is affected by the driver's unnecessary operation like this, the parking assist unit in the comparison example generates the target route TR_target that is also affected by the driver's unnecessary operation. Therefore, there is a possibility that the parking assist unit in the comparison example is not capable of generating the appropriate target route TR_target that allows the vehicle 1 to be parked in the parking space SP efficiently.

On the other hand, FIG. 9 is a planar view that illustrates the target route TR_target generated by the parking assist unit 132 in the present embodiment. In the present embodiment, the parking assist unit 132 generates the target route TR_target on the basis of the start waypoint WP_start, the transit waypoint WP_transit and the complete waypoint WP_end, as described above. Namely, the parking assist unit 132 does not generate the target route TR_target on the basis of the traveling route TR_actual (especially, a line shape of the traveling route TR_actual). Moreover, the parking assist unit 132 generates the target route TR_target by using the transit waypoint WP_transit set on the basis of the shift change waypoint WP_shift instead of directly using the shift change waypoint WP_shift. Namely, the parking assist unit 132 does not necessarily generate the target route TR_target in which the shift range is changed at a position where the driver changes the shift range. Thus, there is lower possibility that the target route TR_target generated by the parking assist unit 132 is affected by the driver's unnecessary operation, compared to the target route TR_target generated by the parking assist unit in the comparison example. Therefore, the parking assist unit 132 is capable of generating the appropriate target route TR_target that allows the vehicle 1 to be parked in the parking space SP more efficiently, compared to the parking assist unit in the comparison example. As a result, the parking assist unit 132 is capable of parking the vehicle 1 in the parking space SP while allowing the vehicle 1 to travel along the appropriate traveling route.

Moreover, the learning unit 131 learns the start waypoint WP start, the shift change waypoint WP_shift and the complete waypoint WP_end corresponding to the traveling route TR_actual having the smallest evaluation score SC1. Namely, the learning part 1311 learns the waypoints WP on the traveling route TR_actual in which the change rate of the curvature is relatively small, the distance from the obstacle is relatively long, the number of the operation of returning the steering wheel is relatively low and/or the length is relatively short. Moreover, the parking assist unit 132 newly sets the transit waypoint WP_transit so that the evaluation score SC2 of the target route TR_target is minimized on the basis of the learned result of the waypoints WP on the traveling route TR_actual in which the change rate of the curvature is relatively small, the distance from the obstacle is relatively long, the number of the operation of returning the steering wheel is relatively low and/or the length is relatively short, and then generates the target route TR_target by using the transit waypoint WP_transit. Thus, the parking assist unit 132 is capable of generating the target route TR_target in which the change rate of the curvature is relatively small, the distance from the obstacle is relatively long, the number of the operation of returning the steering wheel is relatively low and/or the length is relatively short. Therefore, the parking assist unit 132 is capable of generating the appropriate target route TR_target that allows the vehicle 1 to be parked in the parking space SP more efficiently, compared to the parking assist unit in the comparison example. As a result, the parking assist unit 132 is capable of parking the vehicle 1 in the parking space SP while allowing the vehicle 1 to travel along the appropriate traveling route.

Moreover, in the present embodiment, the learning unit 131 need not store an information that relates to a learned result of the traveling route TR_actual itself. Namely, it is enough for the learning unit 131 to store an information that relates to the learned result of the start waypoint WP_start, the shift change waypoint WP_shift and the complete waypoint WP_end. Thus, an amount of the information stored in the learning unit 131 in the present embodiment is smaller than that in the comparison example. Thus, a load of the learning unit 131 for storing the information can be reduced.

### (4) Modified Example

Next, modified examples of the learning process and the parking assist process will be described.

### (4-1) First Modified Example

### (4-1-1) Learning Process in First Modified Example

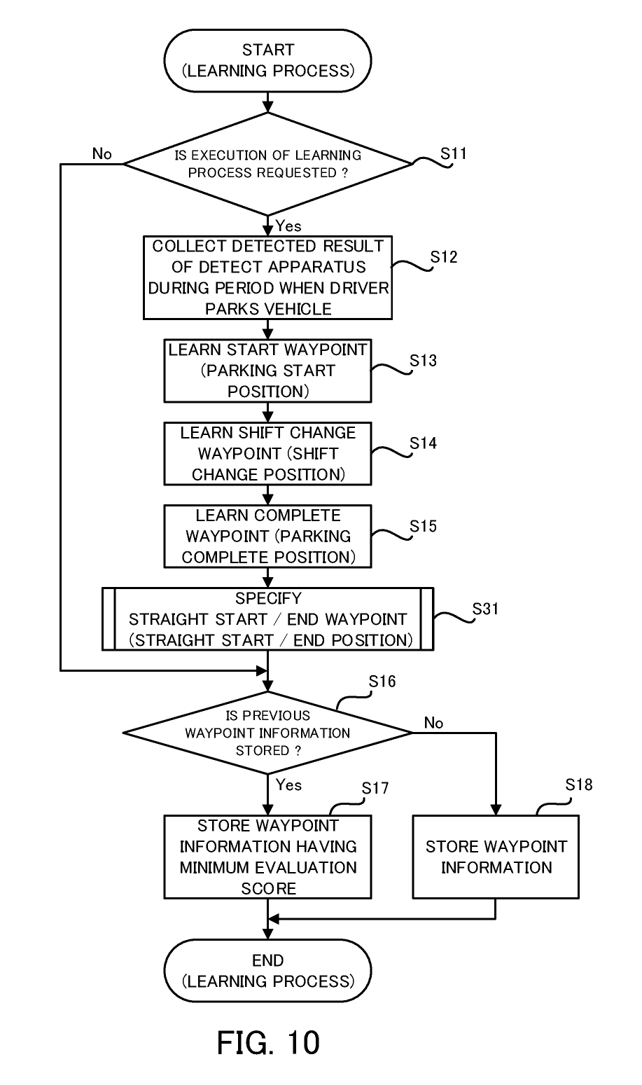

Firstly, with reference to FIG. 10, a flow of the learning process in the first modified example will be described. FIG. 10 is a flowchart that illustrates the flow of the learning process in the first modified example.

As illustrated in FIG. 10, the learning unit 131 also executes the processes from the step S11 to the step S15 in the first modified example. Moreover, in the first modified example, the learning unit 131 specifies a straight traveling start waypoint WP_st1 and a straight traveling end waypoint WP_st2 on the basis of the detection information collected at the step S12 (a step S31). The straight traveling start waypoint WP_st1 corresponds to the position of the vehicle 1 at a timing when a straight traveling period starts, wherein the straight traveling period is a period during which the driver performs a straight traveling operation that contributes to the parking of the vehicle 1. Namely, the straight traveling start waypoint WP_st1 corresponds to the position of the vehicle 1 at a timing when the driver starts to perform the straight traveling operation that contributes to the parking of the vehicle 1. The straight traveling end waypoint WP_st2 corresponds to the position of the vehicle 1 at a timing when the straight traveling period ends. Namely, the straight traveling end waypoint WP_st2 corresponds to the position of the vehicle 1 at a timing when the driver ends the straight traveling operation that contributes to the parking of the vehicle 1.

The straight traveling operation is an operation for allowing the vehicle 1 to travel straightforwardly. The straight traveling operation is typically an operation for making the vehicle 1 travel frontward or backward while steering the steered wheel slightly so that the vehicle 1 travels straightforwardly in the situation where the steered wheel is in the neutral position (namely, while adjusting the steered angle slightly so that the vehicle 1 travels straightforwardly in the situation where the steered angle is zero). The straight traveling operation that contributes to the parking of the vehicle 1 corresponds to a straight traveling operation without which the vehicle 1 cannot be parked in the parking space SP appropriately. Namely, the straight traveling operation that contributes to the parking of the vehicle 1 corresponds to a straight traveling operation without which the vehicle 1 has to travel along an inappropriate traveling route (for example, at least one of a traveling route that is too long and a traveling route that is too curved) in order to park the vehicle 1 in the parking space SP. Therefore, the straight traveling operation that contributes to the parking of the vehicle 1 substantially corresponds to a straight traveling operation that is necessary to park the vehicle 1 in the parking space SP appropriately. In other words, the straight traveling operation that contributes to the parking of the vehicle 1 corresponds to a straight traveling operation other than a straight traveling operation that does not contribute to the parking of the vehicle 1. The straight traveling operation that does not contribute to the parking of the vehicle 1 corresponds to a straight traveling operation without which the vehicle 1 can be parked in the parking space SP appropriately. Namely, the straight traveling operation that does not contribute to the parking of the vehicle 1 substantially corresponds to a straight traveling operation that is unnecessary to park the vehicle 1 in the parking space SP appropriately. In other words, the straight traveling operation that does not contribute to the parking of the vehicle 1 substantially corresponds to an unnecessary (in other words, useless) straight traveling operation.

Note that the straight traveling period during which the driver performs the straight traveling operation does not include a period during which the driver performs the steering operation. Namely, when the driver performs the steering operation, the driver starts to perform the straight traveling operation after ending the steering operation. On the other hand, when the driver performs the straight traveling operation, the driver starts to perform the steering operation after ending the straight traveling operation. Thus, the straight traveling start waypoint WP_st1 is equivalent to the position of the vehicle 1 at a timing when a steering period ends, wherein the steering period is a period during which the driver performs the steering operation. Similarly, the straight traveling end waypoint WP_st2 is equivalent to the position of the vehicle 1 at a timing when the steering period starts.

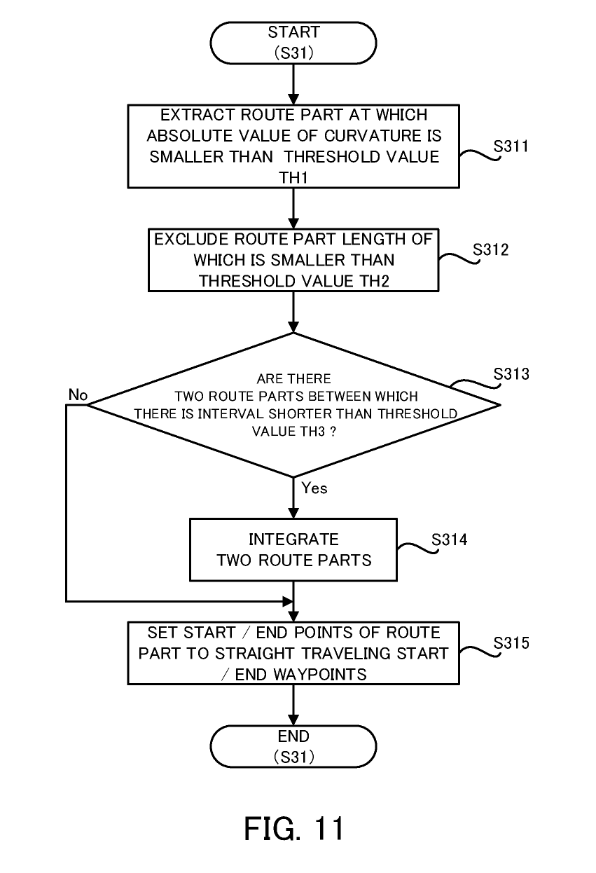

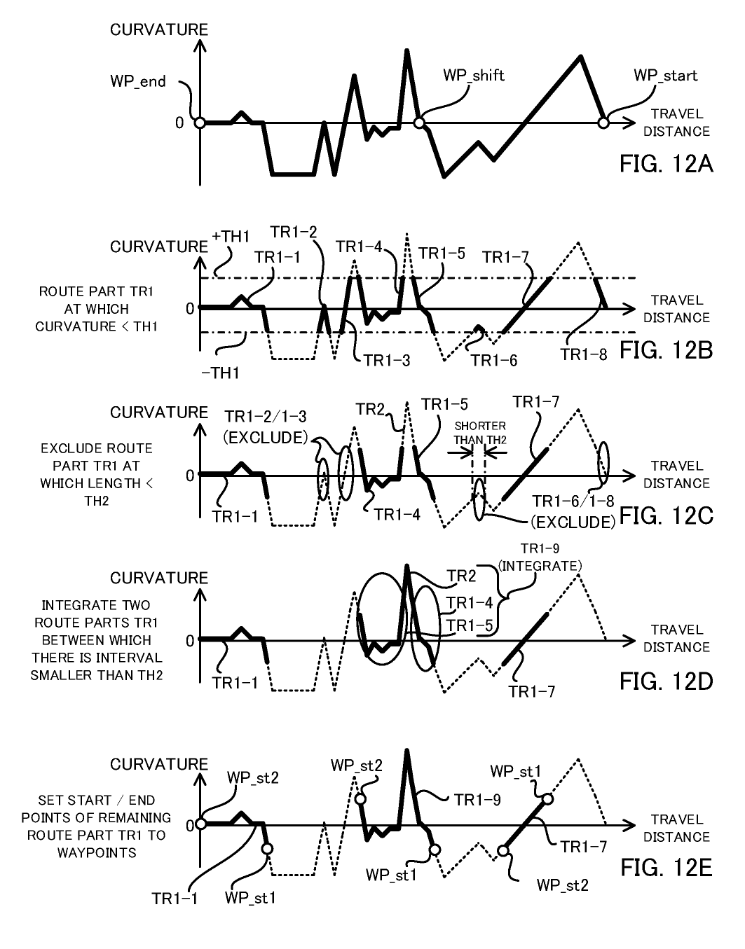

Next, with reference to FIG. 11 and FIG. 12A to FIG. 12E, a process of specifying the straight traveling start waypoint WP_st1 and the straight traveling end waypoint WP_st2 will be described. FIG. 11 is a flowchart that illustrates a flow of the process of specifying the straight traveling start waypoint WP_st1 and the straight traveling end waypoint WP_st2. Each of FIG. 12A to FIG. 12E is a graph that illustrates a curvature of the traveling route TR_actual.

As illustrated in FIG. 11, the WP learning part 1311 extracts, from the traveling route TR_actual, a route part TR1 that is at least one portion of the traveling route TR_actual and at which an absolute value of the curvature is smaller than a predetermined threshold value TH1 (a step S311). Note that the threshold value TH1 is a positive value. For example, when the curvature of the traveling route TR_actual varies as illustrated in FIG. 12A, the WP learning part 1311 extracts a plurality of route parts TR1 (specifically, a route part TR1-1 to a route part TR1-8) at each of which the curvature is smaller than +TH1 and larger than −TH1 as illustrated by thick solid lines in FIG. 12B. Note that the WP learning part 1311 may extract single route part TR1 or may extract no route part TR1 although FIG. 12B illustrates an example in which the WP learning part 1311 extracts the plurality of route parts TR1.

When the absolute value of the curvature is larger than the threshold value TH1 (namely, is relatively large), there is a higher possibility that the driver performs the steering operation that contributes to the parking of the vehicle 1, compared to the case where the absolute value of the curvature is smaller than the threshold value TH1 (namely, is relatively small). Thus, there is a relatively high possibility that the driver performs the steering operation that contributes to the parking of the vehicle 1 during a period during which the absolute value of the curvature is larger than the threshold value TH1. Note that the steering operation that contributes to the parking of the vehicle 1 corresponds to the steering operation other than the above described unnecessary steering operation that does not contribute to the parking of the vehicle 1. On the other hand, there is a relatively high possibility that the driver performs the straight traveling operation that contributes to the parking of the vehicle 1 during a period during which the absolute value of the curvature is smaller than the threshold value TH1. Thus, the WP learning part 1311 is capable of appropriately specifying (in other words, distinguishing) the straight traveling operation and the steering operation on the basis of the curvature.

Incidentally, it is preferable that the threshold value TH1 be set to an appropriate value that allows the WP learning part 1311 to distinguish the straight traveling operation from the steering operation on the basis of the curvature of the traveling route of the vehicle 1, considering the above described technical reason why the WP learning part 1311 determines a magnitude relationship between the threshold value TH1 and the curvature of the traveling route TR_actual.

On the other hand, even if the route part TR1 at which the absolute value of the curvature is smaller than the threshold value TH1 is extracted, if a length of the extracted route part TR1 is relatively short, there is a relatively high possibility that the driver performs only the steering operation for reversing the steered wheel so that the position of the steered wheel returns to the neutral position at the extracted route part TR1 in the middle of repeatedly steering the steered wheel unnecessarily. Namely, there is a relatively high possibility that the driver performs the straight traveling operation that does not contribute to the parking of the vehicle 1 at the route part TR1 at which the absolute value of the curvature is smaller than the threshold value TH1 and the length of which is relatively short.

Thus, the WP learning part 1311 excludes the route part TR1 the length of which is shorter than a predetermined threshold value TH2 among the route part(s) TR1 extracted at the step S311 (a step S312). For example, when the route part TR1-1 to the route part TR1-8 are extracted at the step S311 as illustrated by the thick solid lines in FIG. 12B, the WP learning part 1311 excludes four route parts TR1-2, TR1-3, TR1-6 and TR1-8 the length of each of which is shorter than the threshold value TH2 as illustrated in FIG. 12C. As result of the execution of the step S312, the WP learning part 1311 substantially extracts the route part TR1 at which the absolute value of the curvature is smaller than the threshold value TH1 and the length of which is larger than the threshold value TH2. As a result, the WP learning part 1311 is capable of appropriately specifying the route part TR1 that corresponds to the straight traveling period during which the driver performs the straight traveling operation that contributes to the parking of the vehicle 1 on the basis of not only the curvature but also the length.

Incidentally, it is preferable that the threshold value TH2 be set to an appropriate value that allows the WP learning part 1311 to distinguish the straight traveling operation that contributes to the parking of the vehicle 1 from the straight traveling operation that does not contribute to the parking of the vehicle 1 on the basis of the length of the route part TR1, considering the above described technical reason why the WP learning part 1311 determines a magnitude relationship between the threshold value TH2 and the length of the route part TR1.

Then, the WP learning part 1311 determines whether or not the route parts TR1 extracted at the step S311 and not excluded at the step S312 include two adjacent route parts TR1 between which there is an interval a length of which is smaller than a predetermined threshold value TH3 (a step S313). Note that the threshold value TH3 is a positive value. Namely, if the traveling route TR_actual is divided into the route part TR1 and a route part TR2 other than the route part TR1 (namely, a route part TR2 at which the absolute value of the curvature is larger than the threshold value TH1 or the length of which is shorter than the threshold value TH2), the WP learning part 1311 determines whether or not there are two adjacent route parts TR1 between which there is the route part TR2 the length of which is smaller than the threshold value TH3 (the step S313). Hereinafter, two adjacent route part TR1 between which there is the route part TR2 the length of which is smaller than the third threshold value TH3 are referred to as “one route part TR1” and “the other route part TR1”, respectively.

As a result of the determination at the step S313, if it is determined that there are two adjacent route parts TR1 between which there is the route part TR2 the length of which is smaller than the threshold value TH3 (the step S313: Yes), it is presumed that the driver performs the straight traveling operation performed at one route part TR1 soon after or before performing the straight traveling operation performed at the other route part TR1. In this case, it matters little if the straight traveling operation performed at one route part TR1 and the straight traveling operation performed at the other route part TR1 are regarded as a series of straight traveling operation that contributes to the parking of the vehicle 1. Thus, the WP learning part 1311 integrates these two route parts TR1 and the route part TR2 that is between these two route parts TR1 and set the route part obtained by the integration to new one route part TR1 (a step S314). For example, when there remain the route parts TR1-1, TR1-4, TR1-5 and TR1-7 as illustrated by thick solid lines in FIG. 12C, the WP learning part 1311 integrates the route parts TR1-4 and TR1-5 and the route part TR2 that is between the route parts TR1-4 and TR1-5 and set the route part obtained by the integration to new one route part TR1-9, as illustrated in FIG. 12C and FIG. 12D.

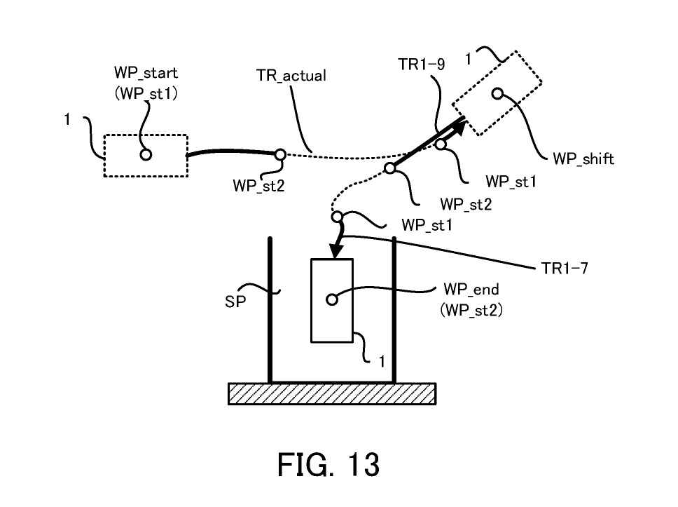

Then, the WP learning part 1311 specifies a position of a start point (in other words, a beginning point) of the remaining route part TR1 as the straight traveling start waypoint WP_st1 (a step S315). Moreover, the WP learning part 1311 specifies a position of an end point of the remaining route part TR1 as the straight traveling end waypoint WP_st2 (the step S315). For example, when there remain the route parts TR1-1, TR1-7 and TR1-9 as illustrated by thick solid lines in FIG. 12E, the WP learning part 1311 specifies a position of the start point of each of the route parts TR1-1, TR1-7 and TR1-9 as the straight traveling start waypoint WP_st1. Moreover, the WP learning part 1311 specifies a position of the end point of each of the route parts TR1-1, TR1-7 and TR1-9 as the straight traveling end waypoint WP_st2. Note that FIG. 13 illustrates one example of a relationship between the straight traveling start waypoint WP_st1 and the straight traveling end waypoint WP_st2 illustrated in FIG. 12E and the traveling route TR_actual.

Again in FIG. 10, the WP learning part 1311 makes the WP storing part 1312 store the WP information including an information set of the learned start waypoint WP_start, the learned shift change waypoint WP_shift, the learned complete waypoint WP_end, the learned straight traveling start waypoint WP_st1 and the learned straight traveling end waypoint WP_st2 (the step S18). However, if it is determined that the WP information obtained in the past is already stored in the WP storing part 1312 (the step S16: Yes), the WP learning part 1311 makes the WP storing part 1312 store the WP information having the smaller evaluation score SC1 (namely, the smallest evaluation score SC1) among the previous WP information and the new WP information (the step S17).

### (4-1-2) Parking Assist Process in First Modified Example

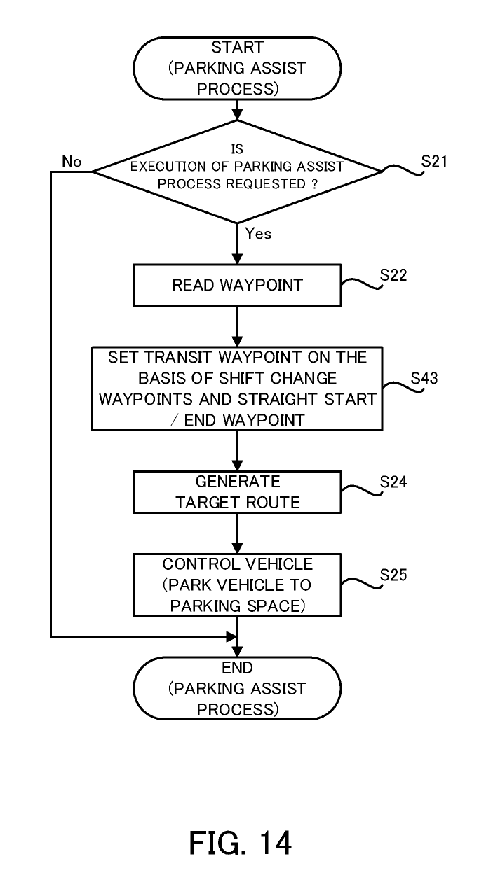

Next, with reference to FIG. 14, a flow of the parking assist process in the first modified example will be described. FIG. 14 is a flowchart that illustrates the flow of the parking assist process in the first modified example.

As illustrated in FIG. 14, the parking assist unit 132 also executes the processes from the step S21 to the step S22 in the first modified example.

Then, the route generating part 1322 sets the transit waypoints WP_transit on the basis of the shift change waypoint WP_shift, the straight traveling start waypoint WP_st1 and the straight traveling end waypoint WP_st2 included in the WP information read at the step S22 (a step S43). Specifically, the route generating part 1322 sets a first transit waypoint WP_transit1 on the basis of the shift change waypoint WP_shift. Moreover, the route generating part 1322 sets a second transit waypoint WP_transit2 on the basis of the straight traveling start waypoint WP_st1 by using a method that is same as a method of setting the first transit waypoint WP_transit1 on the basis of the shift change waypoint WP_shift. Moreover, the route generating part 1322 sets a third transit waypoint WP_transit3 on the basis of the straight traveling end waypoint WP_st2 by using a method that is same as the method of setting the first transit waypoint WP_transit1 on the basis of the shift change waypoint WP_shift. Namely, the route generating part 1322 sets the first transit waypoint WP_transit1 to the third transit waypoint WP_transit3 so that the evaluation score SC2 is minimized. Note that the evaluation score SC2 in the first modified example is a quantitative index value that represents an optimum degree of a traveling route TR_candidate that reaches the complete waypoint WP_end from the current position of the vehicle 1 or the start waypoint WP_start via a first candidate waypoint WP_candidate1 to a third candidate waypoint WP_candidate3 that are candidates of the first transit waypoint WP_transit1 to the third transit waypoint WP_transit3, respectively.

Then, the route generating part 1322 generates, as the target route TR_target along which the vehicle 1 should travel, a traveling route that reaches the complete waypoint WP_end included in the WP information read at the step S22 from the current position of the vehicle 1 or the start waypoint WP_start included in the WP information read at the step S22 via the first transit waypoint WP_transit1 to the third transit waypoint WP_transit3 set at the step S43 (the step S24). Then, the vehicle controlling part 1323 makes the vehicle 1 automatically travel along the target route TR_target generated at the step S24 (the step S25).

### (4-1-3) Technical Effect in First Modified Example

According to the learning process and the parking assist process in the first modified example, it is possible to achieve a technical effect that is same as the technical effect achieved by the learning process and the parking assist process in the above described embodiment.

Moreover, in the first modified example, the parking assist unit 132 uses the straight traveling start waypoint WP_st1 and the straight traveling end waypoint WP_st2 in generating the target route TR_target, in order to allow the route part TR1 at which the driver performs the straight traveling operation that contributes to the parking of the vehicle 1 to be reflected in the target route TR_target. Thus, the route generating part 1322 is capable of generating more appropriate target route TR_target (especially, the target route TR_target that is less likely affected by the unnecessary steering operation) based on the straight traveling operation that contributes to the parking of the vehicle 1.

Moreover, if two adjacent route parts TR1 between which there is the route part TR2 the length of which is smaller than the threshold value TH3 are integrated, the number of the route part(s) TR1 that remain(s) to the end is reduced. Thus, the number of the straight traveling start waypoint(s) WP_st1 and the straight traveling end waypoint(s) WP_st2 is also reduced. Thus, the route generating part 1322 is capable of generating more efficient target route TR_target that is less likely affected by the unnecessary steering operation.

### (4-2) Second Modified Example

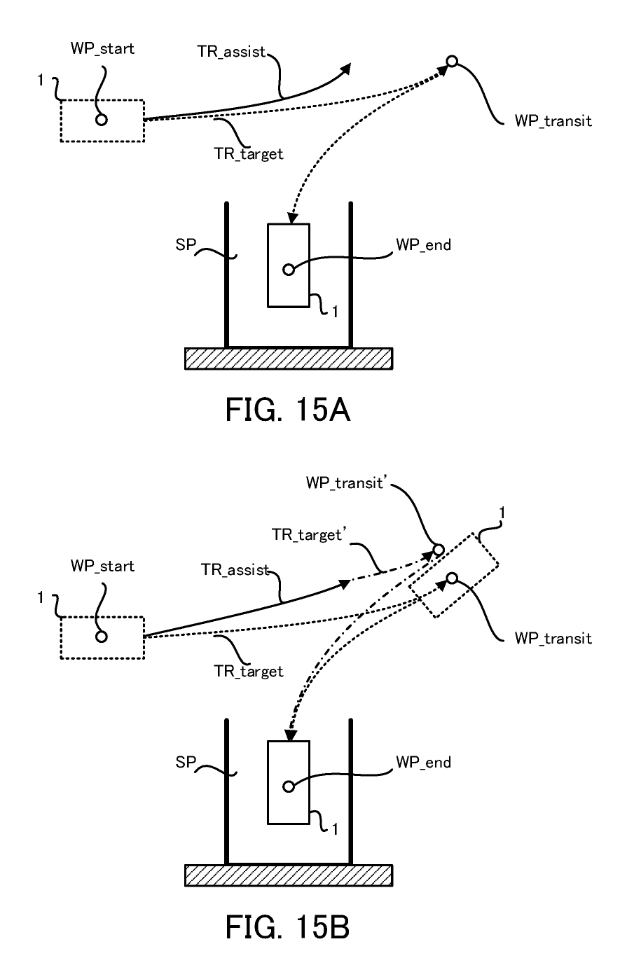

As described above, the vehicle controlling part 1323 makes the vehicle 1 automatically travel along the target route TR_target after the target route TR_target is generated. Namely, the vehicle controlling part 1323 automatically parks the vehicle 1 in the parking space SP in accordance with the target route TR_target. However, there is a possibility that the vehicle 1 traveling under the control of the vehicle controlling part 1323 deviates from the target route TR_target due to any reason as illustrated in FIG. 15A. Namely, there is a possibility that an actual traveling route TR_assist of the vehicle 1 traveling under the control of the vehicle controlling part 1323 is away from the target route TR_target due to any reason. In this case, there is a possibility that the vehicle 1 cannot be appropriately parked in the parking space SP.

Thus, in the second modified example, the route generating part 1322 determines whether or not the vehicle 1 traveling under the control of the vehicle controlling part 1323 deviates from the target route TR_target by a predetermined amount or more. Namely, the route generating part 1322 determines whether or not the traveling route TR_assist is away from the target route TR_target by the predetermined amount or more. If it is determined that the traveling route TR_assist is away from the target route TR_target by the predetermined amount, the route generating part 1322 generates new target route TR_target′ as illustrated in FIG. 15B. Specifically, the route generating part 1322 sets, on the basis of the already set transit waypoint WP_transit, new transit waypoint WP_transit′ through which the new target route TR_target′ passes. A process of setting the new transit waypoint WP_transit′ on the basis of the already set transit waypoint WP_transit is same as a process of setting the transit waypoint WP_transit on the basis of the shift change waypoint WP_shift, and thus, a detailed description thereof is omitted. Then, the route generating part 1322 generates, as the new target route TR_target′, a traveling route that reaches the complete waypoint WP_end from the current position of the vehicle 1 via the new transit waypoint WP_transit′. As a result, even if the vehicle 1 traveling under the control of the vehicle controlling part 1323 deviates from the target route TR_target by the predetermined amount or more, the parking assist unit 132 is capable of parking the vehicle 1 in the parking space SP while allowing the vehicle 1 to travel along the appropriate traveling route.

### (4-3) Another Modified Example

In the above described description, the route generating part 1322 sets the plurality of candidate waypoints WP_candidate in the predetermined area CA and then selects one of the plurality of candidate waypoints WP_candidate as the transit waypoint WP_transit at the step S23 in FIG. 6. However, the route generating part 1322 may search the transit waypoint WP_transit achieving the smallest evaluation score SC2 in the predetermined area CA by using a non-linear least method, in addition to or instead of setting the plurality of candidate waypoints WP_candidate.

In the above described description, the route generating part 1322 sets the transit waypoint WP_transit so that the evaluation score SC2 is minimized at the step S23 in FIG. 6. However, when the evaluation score SC2 is small to some extent, there is a possibility that the target route TR_target that passes through the transit waypoint WP_transit corresponding to that evaluation score SC2 is appropriate to some extent (namely, the unnecessary traveling is reduced if the vehicle 1 is parked in the parking space SP in accordance with the target route TR_target). Thus, the route generating part 1322 may set the transit waypoint WP_transit so that the evaluation score SC2 is equal to or smaller than a first threshold value that allows the route generating part 1322 to distinguish a situation where the target route TR_target is appropriate from a situation where the target route TR_target is not appropriate on the basis of the evaluation score SC2.

In the above described description, the WP learning part 1311 makes the WP storing part 1312 store one WP information having the smaller evaluation score SC1 (namely, the smallest evaluation score SC1) at the step S17 in FIG. 2. However, the WP learning part 1311 may make the WP storing part 1312 store a plurality of WP information. For example, when the evaluation score SC1 is small to some extent, there is a possibility that the traveling route TR_actual corresponding to that evaluation score SC1 is appropriate to some extent (namely, the traveling route TR_actual is allowed to be used to generate the target route TR_target in the parking assist process). Thus, the WP learning part 1311 may make the WP storing part 1312 store a plurality of WP information each of which has the evaluation score SC1 that is equal to or smaller than a second threshold value that allows the WP learning part 1311 to distinguish a situation where the traveling route TR_actual is appropriate from a situation where the traveling route TR_actual is not appropriate on the basis of the evaluation score SC1. When the plurality of WP information are stored by the WP storing part 1312, the route generating part 1322 may set the plurality of candidate waypoints WP candidate in the predetermined area CA including the plurality of shift change waypoints WP_shift that are included in the plurality of WP information, respectively.

In the above described description, the evaluation score SC2 is defined so that the evaluation score SC2 becomes smaller as the traveling route TR_candidate becomes more appropriate. However, the evaluation score SC2 may be defined so that the evaluation score SC2 becomes larger as the traveling route TR_candidate becomes more appropriate. In this case, the route generating part 1322 may set the transit waypoint WP_transit so that the evaluation score SC2 becomes larger (namely, the largest) at the step S23 in FIG. 6. Alternatively, the route generating part 1322 may set the transit waypoint WP_transit so that the evaluation score SC2 is equal to or larger than a third threshold value that allows the route generating part 1322 to distinguish the situation where the target route TR_target is appropriate from the situation where the target route TR_target is not appropriate on the basis of the evaluation score SC2.

Similarly, in the above described description, the evaluation score SC1 is defined so that the evaluation score SC1 becomes smaller as the traveling route TR_actual becomes more appropriate. However, the evaluation score SC1 may be defined so that the evaluation score SC1 becomes larger as the traveling route TR_actual becomes more appropriate. In this case, the WP learning part 1311 may make the WP storing part 1312 store the WP information having the larger evaluation score SC1 (namely, the largest evaluation score SC1) at the step S17 in FIG. 2. Alternatively, the WP learning part 1311 may make the WP storing part 1312 store a plurality of WP information each of which has the evaluation score SC1 that is equal to or larger than a fourth threshold value that allows the WP learning part 1311 to distinguish the situation where the traveling route TR_actual is appropriate from the situation where the traveling route TR_actual is not appropriate on the basis of the evaluation score SC1.

In the above described description, the WP learning part 1311 calculates the evaluation score SC1 and then makes the WP storing part 1312 store the WP information having the smallest evaluation score SC1 (alternatively, having the evaluation score SC1 that is equal to or smaller than the first threshold value) in the learning process. However, the WP learning part 1311 may makes the WP storing part 1312 store the obtained WP information without calculating the evaluation score SC1. In this case, the route generating part 1322 may calculate the evaluation score SC1 for the WP information stored by the WP storing part 1312 and then may select at least one WP information that is used to generate the target route TR_target from the WP information stored by the WP storing part 1312 on the basis of the calculated evaluation score SC1. For example, the route generating part 1322 may select the WP information having the smallest evaluation score SC1.

In the above described description, the learning unit 131 learns at least one of the shift change waypoint WP_shift, the straight traveling start waypoint WP_st1 and the straight traveling end waypoint WP_st2 in order to set the transit waypoint WP_transit. The shift change waypoint WP_shift is the position of the vehicle 1 at the shift change timing at which the driver changes the shift range in order to park the vehicle 1 (namely, at the timing at which the traveling direction of the vehicle 1 is changed). The straight traveling start waypoint WP_st1 is the position of the vehicle 1 at the timing when the straight traveling period during which the driver performs the straight traveling operation to park the vehicle 1 starts (namely, at the timing when a period during which the vehicle 1 travels straightforwardly starts). The straight traveling end waypoint WP_st2 is the position of the vehicle 1 at the timing when the straight traveling period during which the driver performs the straight traveling operation to park the vehicle 1 ends (namely, at the timing when the period during which the vehicle 1 travels straightforwardly ends). Thus, the above described waypoints used to set the transit waypoint WP_transit corresponds to the position of the vehicle 1 at a timing at which a behavior of the vehicle 1 is same as a predetermined behavior that contributes to the parking of the vehicle 1. In this case, the learning unit 131 may learn, as the waypoint to set the transit waypoint WP_transit, the position of the vehicle 1 at the timing at which the behavior of the vehicle 1 is same as the predetermined behavior that contributes to the parking of the vehicle 1, in addition to or instead of at least one of the shift change waypoint WP_shift, the straight traveling start waypoint WP_st1 and the straight traveling end waypoint WP_st2. Moreover, the route generating part 1322 may set the transit waypoint WP_transit on the basis of the learned waypoint WP by using a method that is same as the method of setting the transit waypoint WP_transit on the basis of the shift change waypoint WP_shift.

In the above described description, the evaluation score SC1 is the index value determined on the basis of the change rage of the curvature of the traveling route TR_actual, the distance between the traveling route TR_actual and the obstacle, the number of returning the steering wheel in the vehicle 1 traveling along the traveling route TR_actual and the length of the traveling route TR_actual. However, the evaluation score SC1 may be the index value that has no relationship with at least one of the change rage of the curvature of the traveling route TR_actual, the distance between the traveling route TR_actual and the obstacle, the number of returning the steering wheel in the vehicle 1 traveling along the traveling route TR_actual and the length of the traveling route TR_actual. For example, the evaluation score SC1 may be the index value that is determined on the basis of the change rage of the curvature of the traveling route TR_actual and the distance between the traveling route TR_actual and the obstacle and that has no relationship with the number of returning the steering wheel in the vehicle 1 traveling along the traveling route TR_actual and the length of the traveling route TR_actual. Same applies to the evaluation score SC2.

The evaluation score SC1 may be the index value that is determined on the basis of another parameter in addition to or instead of at least one of the change rage of the curvature of the traveling route TR_actual, the distance between the traveling route TR_actual and the obstacle, the number of returning the steering wheel in the vehicle 1 traveling along the traveling route TR_actual and the length of the traveling route TR_actual. For example, the evaluation score SC1 may be an index value that is determined on the basis of a time required for the vehicle 1 to travel along the traveling route TR_actual. Specifically, the evaluation score SC1 may be an index value that is determined on the basis of the premise that the traveling route TR_actual becomes more appropriate as the time required for the vehicle to travel along the traveling route TR_actual becomes shorter, for example. Alternatively, for example, the evaluation score SC1 may be an index value that is determined on the basis of a speed of the vehicle 1 traveling along the traveling route TR_actual. Specifically, the evaluation score SC1 may be an index value that is determined on the basis of the premise that the traveling route TR_actual becomes more appropriate as the speed of the vehicle 1 traveling along the traveling route TR_actual becomes lower, for example. Alternatively, for example, the evaluation score SC1 may be an index value that is determined on the basis of an attitude (for example, an angle with respect to the parking space SP) of the vehicle 1 at the parking complete timing. Specifically, the evaluation score SC1 may be an index value that is determined on the basis of the premise that the traveling route TR_actual becomes more appropriate as a difference between the actual attitude of the vehicle 1 at the parking complete timing and a desired attitude based on the parking space SP becomes smaller, for example. Same applies to the evaluation score SC2.

The weighting factors w1a to w1d and w2a to w2d that are used to calculate the evaluation scores SC1 and SC2 may be set on the basis of evaluation from the driver to the target route TR_target generated by the route generating part 1322. For example, if the evaluation from the driver to the target route TR_target is stored (recorded), it is possible to determine, on the basis of the stored evaluation, a tendency of the driver, namely, whether or not the driver emphasizes the change rage of the curvature of the target route TR_target, whether or not the driver emphasizes the distance between the target route TR_target and the obstacle, whether or not the driver emphasizes the number of returning the steering wheel and/or whether or not the driver emphasizes the length of the target route TR_target. Thus, the learning unit 131 and/or the parking assist unit 132 may determine which parameter(s) tends to be emphasized by the driver and increase the weighting factor corresponding to the emphasized parameter.

### (5) Additional Statement

Relating to the above described embodiment, following additional statements will be disclosed.

### (5-1) Additional Statement 1

A parking assist apparatus according to the additional statement 1 is a parking assist apparatus having: a learning device that is configured to learn a specific position during a period when a driver performs a parking operation for parking a vehicle, the specific position being a position of the vehicle when a behavior of the vehicle satisfies a predetermined condition; a setting device that is configured to set a transit position in a first predetermined area that includes the specific position learned by the learning device; and a generating device that is configured to generate, as a target route along which the vehicle should travel when the vehicle is automatically parked at a target position at which the vehicle should be parked, a first traveling route that reaches the target position via the transit position set by the setting device, the setting device is configured to set the transit position on the basis of a first evaluation score of the first traveling route, wherein the first evaluation score is determined on the basis of at least a change rate of a curvature of the first traveling route and/or a distance between the first traveling route and a first obstacle that exists around the first traveling route.

Alternatively, a parking assist apparatus according to the additional statement 1 may be a parking assist apparatus having a controller, the controller being programmed to learn a specific position during a period when a driver performs a parking operation for parking a vehicle, the specific position being a position of the vehicle when a behavior of the vehicle satisfies a predetermined condition; set a transit position in a first predetermined area that includes the learned specific position; and generate, as a target route along which the vehicle should travel when the vehicle is automatically parked at a target position at which the vehicle should be parked, a first traveling route that reaches the target position via the set transit position, the controller is programmed to set the transit position on the basis of a first evaluation score of the first traveling route, wherein the first evaluation score is determined on the basis of at least a change rate of a curvature of the first traveling route and/or a distance between the first traveling route and a first obstacle that exists around the first traveling route.

In the parking assist apparatus according to the additional statement 1, it is enough for the learning device to learn the specific position. Namely, the learning device need not learn the traveling route itself along which the vehicle actually travels when the driver performs the parking operation. In addition, the setting device is capable of setting, in the first predetermined area including the specific position, the transit position through which the actual target route passes. Thus, the parking assist apparatus according to the additional statement 1 is capable of generating the target route that is less likely affected by a driver's unnecessary operation, compared to a parking assist apparatus in a comparison example that is configured to generate the target route on the basis of the learned result of the traveling route itself along which the vehicle actually travels when the driver performs the parking operation. Namely, the parking assist apparatus according to the additional statement 1 is capable of generating the appropriate target route that allows the vehicle to be parked in a parking space more efficiently, compared to the parking assist apparatus in the comparison example. As a result, the parking assist apparatus according to the additional statement 1 is capable of parking the vehicle in the parking space while allowing the vehicle to travel along the appropriate (in other words, desired) traveling route.

### (5-2) Additional Statement 2

A parking assist apparatus according to the additional statement 2 is the parking assist apparatus according to the additional statement 1, wherein the first evaluation score becomes smaller as the change rate of the curvature of the first traveling route becomes smaller and/or the first evaluation score becomes smaller as the distance between the first traveling route and the first obstacle becomes larger, the setting device is configured to (alternatively, the controller is programmed to) set the transit position so that the first evaluation score is equal to or smaller than a predetermined first threshold value or is minimized.

The parking assist apparatus according to the additional statement 2 allows the setting device (alternatively, the controller) to set the transit position so that the change rate of the curvature of the target route becomes relatively small and/or the distance between the target route and the first obstacle becomes relatively large.

Note that the first evaluation score may become larger as the change rate of the curvature of the first traveling route becomes smaller and/or the first evaluation score may become larger as the distance between the first traveling route and the first obstacle becomes larger, the setting device may configured to (alternatively, the controller may be programmed to) set the transit position so that the first evaluation score is equal to or larger than a predetermined third threshold value or is maximized. In this case, the setting device (alternatively, the controller) is capable of setting the transit position so that the change rate of the curvature of the target route becomes relatively small and/or the distance between the target route and the first obstacle becomes relatively large.

### (5-3) Additional Statement 3

A parking assist apparatus according to the additional statement 3 is the parking assist apparatus according to the additional statement 1 or 2, wherein the specific position includes at least one of a position of the vehicle when the driver changes a shift range of the vehicle, a position of the vehicle at the beginning of a period during which the driver performs a straight travelling operation as one portion of the parking operation and a position of the vehicle at the end of the period during which the driver performs the straight travelling operation as one portion of the parking operation, the straight traveling operation is an operation that allows the vehicle to travel straightforwardly to contribute to the parking of the vehicle.

The parking assist apparatus according to the additional statement 3 allows the setting device (alternatively, the controller) to set the transit position on the basis of the specific position that corresponds to the position of the vehicle when the behavior of the vehicle is same as a predetermined behavior that contributes to the parking of the vehicle.

### (5-4) Additional Statement 4

A parking assist apparatus according to the additional statement 4 is the parking assist apparatus according to any one of the additional statements 1 to 3, wherein the setting device is configured to (alternatively, the controller is programmed to) set the transit position in the first predetermined area that includes desired specific position when the driver performs the parking operation twice or more, the desired specific position is selected from two or more specific positions that correspond to the two or more parking operations, respectively, on the basis of second evaluation scores, the second evaluation score is determined for each parking operation on the basis of at least a change rate of a curvature of a second traveling route along which the vehicle travels by each parking operation and/or a distance between the second traveling route and a second obstacle that exists around the second traveling route.

The parking assist apparatus according to the additional statement 4, allows the setting device (alternatively, the controller) to set the transit position appropriately, even if the driver performs the parking operation twice or more.

### (5-5) Additional Statement 5

A parking assist apparatus according to the additional statement 5 is the parking assist apparatus according to the additional statement 4, wherein the second evaluation score becomes smaller as the change rate of the curvature of the second traveling route becomes smaller and/or the second evaluation score becomes smaller as the distance between the second traveling route and the second obstacle becomes larger, the desired specific position is the specific position corresponding to a desired second traveling route in which the second evaluation score is equal to or smaller than a predetermined second threshold value or is minimized, among two or more second traveling routes along which the vehicle travels by two or more parking operations, respectively

In the parking assist apparatus according to the additional statement 5, if the transit position is set by using the second traveling route in which the change rate of the curvature of the second traveling route is relatively small, there is a high possibility that the change rate of the curvature of the target route is also relatively small. Moreover, there is a high possibility that the second obstacle that exists around the second traveling route along which the vehicle actually travels to reach the target position is at least partially same as the first obstacle that exists around the first traveling route generated by the generating device (alternatively, the controller) to generate the target route that reaches the target position. Thus, if the transit position is set by using the second traveling route in which the distance between the second traveling route and the second obstacle is relatively large, there is a high possibility that the distance between the target route and the first obstacle is also relatively large. Thus, the setting device (alternatively, the controller) is capable of setting the transit position so that the change rate of the curvature of the target route becomes relatively small and/or the distance between the target route and the first obstacle becomes relatively large.

Note that the second evaluation score may become larger as the change rate of the curvature of the second traveling route becomes smaller and/or the second evaluation score may become larger as the distance between the second traveling route and the second obstacle becomes larger, and the setting device may be configured to (alternatively, the controller may be programmed to) set the transit position in the first predetermined area including the specific position that corresponds to one second traveling route in which the second evaluation score is equal to or larger than a predetermined fourth threshold value or is maximized, among two or more second traveling routes along which the vehicle travels by two or more parking operations, respectively. In this case, the setting device (alternatively, the controller) is capable of setting the transit position so that the change rate of the curvature of the target route becomes relatively small and/or the distance between the target route and the first obstacle becomes relatively large.

### (5-6) Additional Statement 6

A parking assist apparatus according to the additional statement 6 is the parking assist apparatus according to any one of the additional statements 1 to 5, wherein the setting device is configured to (alternatively, the controller is programmed to) set new transit position in a second predetermined area that includes the previously set transit position on the basis of the first evaluation score, when the vehicle deviates from the target route by a predetermined amount or more during a period when the vehicle is automatically parked in accordance with the target route generated by the generating device (alternatively, by the controller), the generating device is configured to (alternatively, the controller is programmed to) generate, as new target route, the first traveling route that reaches the target position via the new transit position set by the setting device (alternatively, by the controller), when the setting device (alternatively, the controller) sets the new transit position.

The parking assist apparatus according to the additional statement 6 allows the generating device (alternatively, the controller) to appropriately generate new target route in which the change rate of the curvature of new target route becomes relatively small and/or the distance between new target route and the first obstacle becomes relatively large, when the vehicle deviates from the target route by the predetermined amount or more.

At least one portion of the feature in the above described embodiment may be eliminated or modified accordingly. At least one portion of the feature in the above described embodiments may be combined with another one of the above described embodiments.

This application is based upon and claims the benefit of priority of the prior Japanese Patent Application No. 2018-026254, filed on Feb. 16, 2018, the entire contents of which are incorporated herein by reference. In addition, the entire contents of the above described Patent Literatures 1 to 3 are incorporated herein by reference.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention. A parking assist apparatus, which involve such changes, are also intended to be within the technical scope of the present invention.

### REFERENCE SIGNS LIST

1 vehicle
11 external surrounding detect apparatus
12 internal condition detect apparatus
13 ECU
131 learning unit
1311 WP learning part
1312 WP storing part
132 parking assist unit
1321 information reading part
1322 route generating part
1323 vehicle controlling part
TR_actual, TR_candidate, TR_assist traveling route
TR_target target route
WP waypoint
WP_start start waypoint
WP_shift shift change waypoint
WP_end complete waypoint
WP_st1 straight traveling start waypoint
WP_st2 straight traveling end waypoint
WP_transit transit waypoint
WP_candidate candidate waypoint
SP parking space
CA predetermined area

1. A parking assist apparatus comprising a controller,
the controller being programmed to:
learn a specific position during a period when a driver performs a parking operation for parking a vehicle, the specific position being a position of the vehicle when a behavior of the vehicle satisfies a predetermined condition;
set a transit position in a first predetermined area that includes the learned specific position; and
generate, as a target route along which the vehicle should travel when the vehicle is automatically parked at a target position at which the vehicle should be parked, a first traveling route that reaches the target position via the set transit position,
the controller being programmed to set the transit position on the basis of a first evaluation score of the first traveling route, wherein the first evaluation score is determined on the basis of at least a change rate of a curvature of the first traveling route and/or a distance between the first traveling route and a first obstacle that exists around the first traveling route.

2. The parking assist apparatus according to claim 1, wherein
the first evaluation score becomes smaller as the change rate of the curvature of the first traveling route becomes smaller and/or the first evaluation score becomes smaller as the distance between the first traveling route and the first obstacle becomes larger,
the controller is programmed to set the transit position so that the first evaluation score is equal to or smaller than a predetermined first threshold value or is minimized.

3. The parking assist apparatus according to claim 1, wherein
the specific position includes at least one of a position of the vehicle when the driver changes a shift range of the vehicle, a position of the vehicle at the beginning of a period during which the driver performs a straight travelling operation as one portion of the parking operation and a position of the vehicle at the end of the period during which the driver performs the straight travelling operation as one portion of the parking operation, the straight traveling operation is an operation that allows the vehicle to travel straightforwardly to contribute to the parking of the vehicle.

4. The parking assist apparatus according to claim 1, wherein
the controller is programmed to set the transit position in the first predetermined area that includes desired specific position when the driver performs the parking operation twice or more,
the desired specific position is selected from two or more specific positions that correspond to the two or more parking operations, respectively, on the basis of second evaluation scores, the second evaluation score is determined for each parking operation on the basis of at least a change rate of a curvature of a second traveling route along which the vehicle travels by each parking operation and/or a distance between the second traveling route and a second obstacle that exists around the second traveling route.

5. The parking assist apparatus according to claim 4, wherein
the second evaluation score becomes smaller as the change rate of the curvature of the second traveling route becomes smaller and/or the second evaluation score becomes smaller as the distance between the second traveling route and the second obstacle becomes larger,
the desired specific position is the specific position corresponding to a desired second traveling route in which the second evaluation score is equal to or smaller than a predetermined second threshold value or is minimized, among two or more second traveling routes along which the vehicle travels by two or more parking operations, respectively.

6. The parking assist apparatus according to claim 1, wherein
the controller is programmed to set new transit position in a second predetermined area that includes the previously set transit position on the basis of the first evaluation score, when the vehicle deviates from the target route by a predetermined amount or more during a period when the vehicle is automatically parked in accordance with the generated target route,
the controller is programmed to generate, as new target route, the first traveling route that reaches the target position via the set new transit position, when the new transit position is set.
